(19) United States
(12) Patent Application Publication
(10) Pub. No.: US 2014/0297455 A1
(43) Pub. Date: Oct. 2, 2014

(54) ROUTINE SUGGESTION SYSTEM

(71) Applicant: EBAY INC., San Jose, CA (US)

(72) Inventors: Lucy Ma Zhao, Austin, TX (US); Kamal Zamer, Austin, TX (US)

(73) Assignee: EBAY INC., San Jose, CA (US)

(21) Appl. No.: 13/931,176

(22) Filed: Jun. 28, 2013

Related U.S. Application Data
(63) Continuation-in-part of application No. 13/853,455, filed on Mar. 29, 2013.

(51) Int. Cl. G06Q 30/06

(52) U.S. Cl. CPC G06Q 30/0631
USPC 705/26.7

(57) ABSTRACT

Systems and methods for providing routine suggestions include receiving a plurality of user activity data associated with locations within a home location area of a user at a plurality of different times. A subset of the plurality of user activity data is determined to include a location type and a reoccurring time period. A routine identifier is then provided to the user that includes the location type and a plurality of attributes associated with the location type. Routine details that rank the plurality of attributes associated with the location type are then received. A confirmed routine is then associated with the user that includes the location type, the reoccurring time period, and the ranked plurality of attributes. The confirmed routine may then be used to provide routine suggestions that suggest locations to the user to continue with their routines when they are away from the home location area.

### CROSS-REFERENCE TO RELATED APPLICATIONS

This application is a continuation in part of U.S. Patent Application Serial No. 13/853,455, filed Mar. 29, 2013, the disclosure of which is incorporated herein by reference in its entirety.

### BACKGROUND

1. Field of the Invention

The present invention generally relates to online and/or mobile payments and more particularly to system that uses routine purchases in a first location to suggest merchants in a second location.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Consumers often make purchases, sometimes using online and/or mobile payments, at regular, reoccurring time periods. For example, a consumer may regularly purchase coffee during particular time periods (e.g., weekday mornings) at the same coffee merchant in their hometown, or may purchase the same type of coffee during particular time periods at a variety of coffee merchants in their hometown. In another example, a consumer may regularly dine at particular times (e.g., a particular day of the week) at the same restaurant in their hometown, or may dine during particular time periods at the same type of restaurant (e.g., a Italian restaurant) in their hometown. In yet another example, a consumer may regularly exercise at particular times (e.g., a particular day of the week) at the same exercise location in their hometown, and that consumer may then regularly follow that exercise with a particular purchase. Such routines may be disrupted when the consumer leaves their hometown for another location (e.g., due to business, vacation, etc), as the consumer may end up in an unfamiliar location where the time and effort necessary to find the appropriate merchants that will allow the performance of these routines discourages the consumer from doing so.

Thus, there is a need for a routine suggestion system that simplifies the ability of a user to perform their routines in an unfamiliar location.

### BRIEF DESCRIPTION OF THE FIGURES

FIG. 1 is a flow chart illustrating an embodiment of a method for providing routine suggestions;

FIG. 2 is a schematic view illustrating an embodiment of a routine suggestion system;

FIG. 3 is a front view illustrating a user device displaying a routine suggestion screen;

FIG. 4 is a front view illustrating a user device displaying a routine suggestion screen;

FIG. 5 is a front view illustrating a user device displaying a routine suggestion screen;

FIG. 6 is a front view illustrating a user device displaying a routine suggestion screen.

FIG. 7 is a flow chart illustrating an embodiment of a method for providing routine suggestions;

FIG. 8 is a schematic view illustrating an embodiment of a routine suggestion system;

FIG. 9a is a front view illustrating an embodiment of a user device displaying a routine detection screen;

FIG. 9b is a front view illustrating an embodiment of a user device displaying a routine details screen;

FIG. 10a is a front view illustrating an embodiment of a user device displaying a routine detection screen;

FIG. 10b is a front view illustrating an embodiment of a user device displaying a routine details screen;

FIG. 11a is a front view illustrating an embodiment of a user device displaying a routine detection screen;

FIG. 11b is a front view illustrating an embodiment of a user device displaying a routine details screen;

FIG. 11c is a front view illustrating an embodiment of a user device displaying a routine details screen;

FIG. 12 is a schematic view illustrating an embodiment of a networked system;

FIG. 13 is a perspective view illustrating an embodiment of a user device;

FIG. 14 is a schematic view illustrating an embodiment of a computer system; and

FIG. 15 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing user routine suggestions. A user may generate routine data in a home location by making similar purchases in the same time periods. For example, a user may purchase food regularly from the same merchant during the same time period or time periods each week, or purchase the same type of item from different merchants during the same time period or time periods each week. Those purchases may be stored and analyzed to create routine data that is associated with the home location of the user and that may detail repetitive purchasing routines by the user by associating routine purchase types (e.g., purchases from a particular merchant, purchases from type of merchant, purchases of an item type, etc.) with particular time periods. When the user travels to a location (a “current location”) that is more than a predetermined distance from the home location, the systems and methods may determine that a current time corresponds to a time period associated with a routine purchase type and, in response, retrieve merchants that are located in the current location and that provide the routine purchase type associated with the time period. Those merchants may then be displayed on a user device to allow the user to quickly and easily determine a merchant in their current location (away from their home location) at which they may make their routine purchase. Routine data may associate routine purchase types with linked purchase types that are purchases commonly made by the user following a routine purchase type in the home location, and when such a routine purchase type is made in a location that is a predetermined distance from the home location, the systems and methods may retrieve merchants that are located in the current location and that provide the linked purchase types.

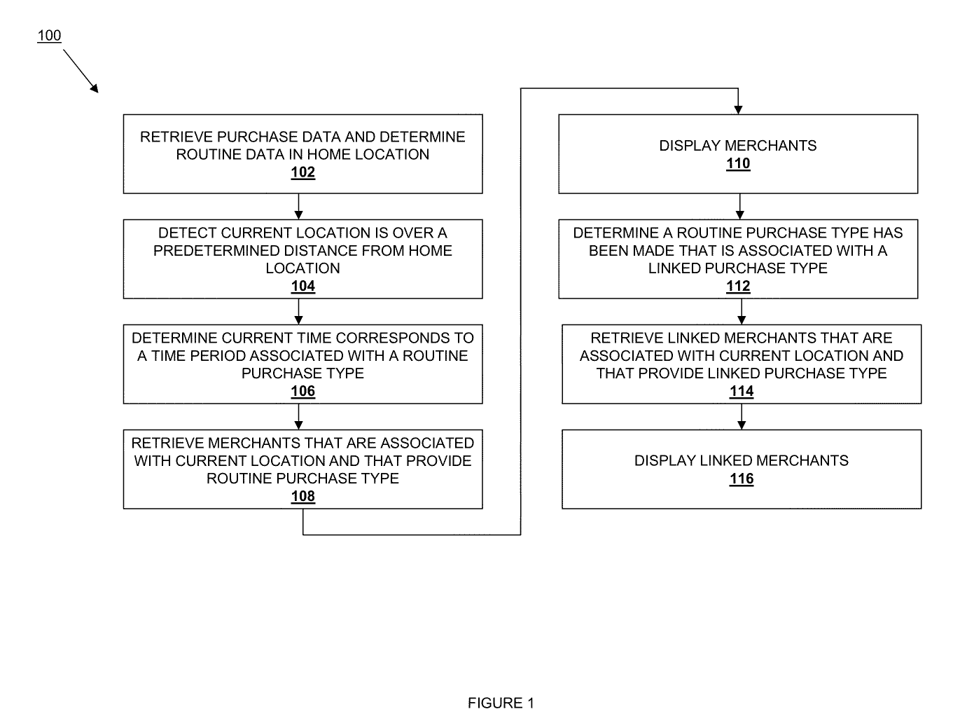

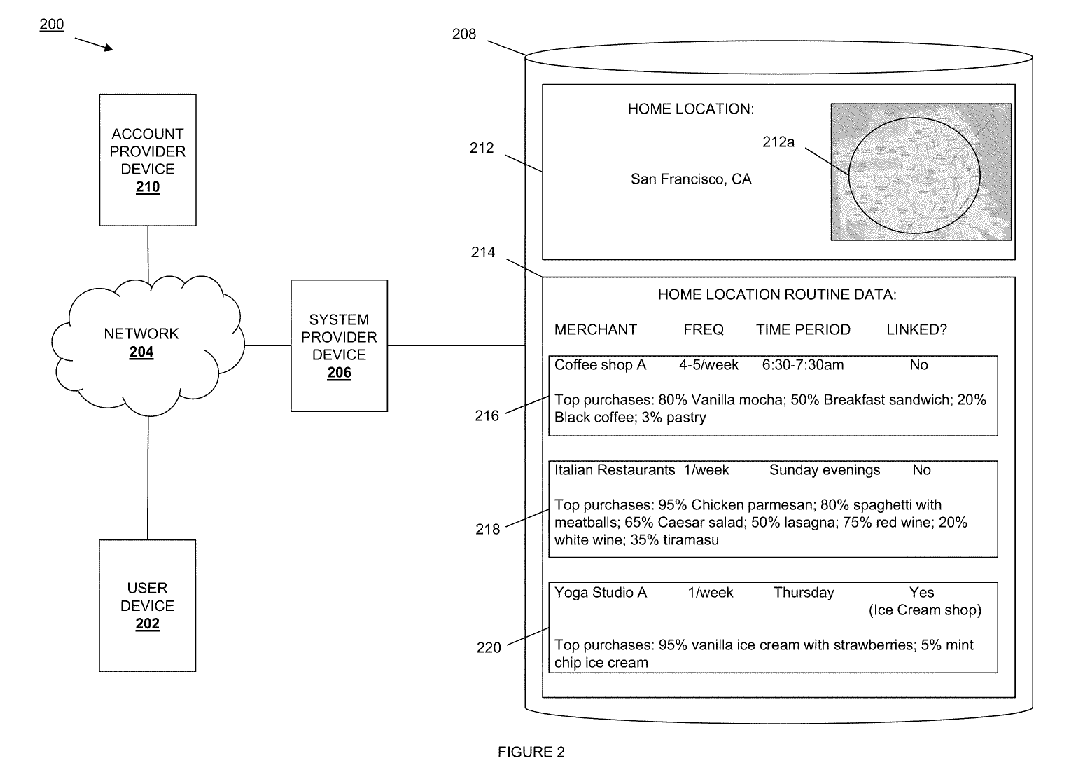

Referring now to FIGS. 1 and 2, an embodiment of a method 100 for providing routine suggestions is illustrated. In an embodiment, a user may be provided a user account by a payment service provider, and that user account will be linked to one or more financial accounts of the user that are provided by account providers. The user may make purchases from merchants using the user account, and those purchases are funded using one of the financial accounts. Thus, in some embodiments, the payment service provider may be the routine suggestion system provider. However, in other embodiments, the routine suggestion system may be provided by an account provider that provides a financial account to the user, a third party system provider that retrieves purchase data from user accounts/financial accounts, and/or a user device.

The method 100 begins at block 102 where purchase data is retrieved and routine data in a home location is determined. Referring now to FIG. 2, an embodiment of a routine suggestion system 200 is illustrated. A user in the routine suggestion system 200 may include a user device 202 that is connected to a network 204 such as, for example, the Internet. A system provider device 206 is connected to the network 204 as well as to a database 208. While the system provider device 206 is illustrated as directly connected to the database 208, the system provider device 206 may be connected to the database 208 through the network 204 while remaining within the scope of the present disclosure. In an embodiment, at block 102 of the method 100, the user may make purchases from merchants using the user device 202 and/or payment devices such as, for example, credit cards, check cards, and/or other payment devices known in the art. For example, the user device 202 may include a mobile phone, and the mobile phone may include a payment application or other payment functionality that allows the user to make payments to merchants via the user device 202. As discussed above, the user may use a user account provided by a payment service provider in order to make purchases from merchants that are funded by one or more financial accounts provided by the payment service provider and/or accounts providers. In another example, the user may present a payment card linked to a financial account provided by the payment service provider and/or accounts providers in order to make purchases from merchants.

Purchase data related to the purchases made using the user device 202 and or payments cards at block 102 of the method 100 may be stored in a database. For example, when the system provider device 206 is operated by a system provider that provides the financial account used by the user to make purchases, purchase data may be stored by the system provider device 206 in the database 208. In another example, purchase data may be stored by an account provider device 210 in a database (not illustrated), and the system provider device 206 may then periodically retrieve that purchase data and store that purchase data in the database 208. In another embodiment, the user device 202 may be the system provider device and may retrieve and store the purchase data from financial institutions of the user. Thus, in some embodiments, the database 208 may be located in the user device 202.

Purchase data related to purchases made by a user may be associated with a home location. In an embodiment, a user may define a home location where the user typically makes purchases (e.g., the location in which the user lives or spends a majority of their time), and that home location may then be saved as home location data 212 in the database 208. In the example illustrated in FIG. 2, the home location data corresponds to an area 212a in San Francisco, Calif. The user may define the home location by selecting the area 212a on a map, providing a home address and a distance from that home address within which purchases will be associated with the home location, providing a city (e.g., San Francisco, Calif.) in which purchases will be associated with the home location, and/or performing a variety of other home location designation actions known in the art. In another embodiment, purchase data may be analyzed to determine a home location. For example, the system provider device may review all purchase data retrieved at block 102 of the method 100, and determine an area within which over a predetermined percentage of purchases are made. In the example illustrated in FIG. 2, the purchase data associated with the user may have been analyzed (e.g., purchases made with the user device 202 that are associated with a GPS location, credit card purchases to a merchant associated with a merchant address, etc.) and determined to include 85% purchases made within the area 212a in San Francisco, Calif. While a few examples of the determination of a home location for a user have been described, one of skill in the art will recognize that a variety of other methods may be used to determine a home location where a user makes the majority of their purchases.

At block 102 of the method 100, the retrieved purchase data that is associated with the home location may then be analyzed to determine routine data in the home location. In an embodiment, the purchase data associated with the home location is analyzed to determine one or more routine purchase types that are each associated with reoccurring time periods. For example, the purchase data associated with the home location may be analyzed to determine purchases from the same or similar merchant (e.g., a particular coffee shop, a plurality of similar coffee shops, a particular restaurant, a plurality of similar restaurants, etc.) that reoccur (e.g., that are made daily, weekly, monthly, etc.) In another example, the purchase data associated with the home location may be analyzed to determine purchases of the same or similar items (e.g., coffee, a type of food, etc.) that reoccur (e.g., that are made daily, weekly, monthly, etc.) For example, a routine purchase type may be determined when a plurality of purchases for a particular item type have been made at a plurality of merchants associated with the home location during a reoccurring time period. The analysis of the purchase data associated with the home location at block 102 of the method 100 results in the determination of routine data for the home location that details reoccurring purchases by the user from similar merchants and/or of similar items.

Furthermore, purchase data may include details of each purchase, and those details may be included in the routine data for the home location. For example, routine data for the home location may include reoccurring purchases made from a particular merchant or similar merchants, along with details about what item, items, service, or services are commonly purchased from the particular merchant or similar merchants.

The analysis of the purchase data at block 102 of the method 100 may also include the determination of linked purchase types that are associated with routine purchase types. As discussed above, the purchase data associated with the home location is analyzed to determine one or more routine purchase types that that are each associated with reoccurring time periods. For each routine purchase type, the system provider device 206 may analyze the purchase data to determine whether a linked purchase is commonly made following the routine purchase type. In an embodiment, a user may make reoccurring purchases from a particular merchant, from similar merchants, or of similar items, and those reoccurring purchases may often be followed by a linked purchase. For example, the system provider device 206 may analyze the purchase data to determine a routine purchase type that involves a particular merchant during a reoccurring time period is followed 65% of the time by a linked purchase that may be from a different particular merchant, similar merchants, or of a particular or similar item, and that linked purchase type may be associated with the routine purchase type in the database 208.

Examples of routine purchase types determined from the analysis of the purchase data at block 102 of the method 100 are illustrated in FIG. 2. In the illustrated embodiment, a plurality of home location routine data 214 is categorized by a merchant, a frequency, a time period, and whether that routine purchase type is associated with a linked purchase type. However, routine purchase data may be categorized by and/or include a variety of other information known in the art that is associated with purchase data without departing from the scope of the present disclosure.

In the illustrated embodiment, the home location routine data 214 includes a routine purchase type 216 that was determined from the purchase data and that details purchases made from a particular merchant (“Coffee Shop A”) that reoccur at a particular time period (between 6:30 and 7:30 am) multiple times per week (4-5 time per week). The routine purchase type 216 is not associated with a linked purchase, but is associated with purchase details that detail the types of purchases made from Coffee Shop A (e.g., a vanilla mocha 80% of the time, a breakfast sandwich 50% of the time, a black coffee 20% of the time, and a pastry 3% of the time.) Thus, the user may purchase coffee each weekday morning in their home location from the same coffee shop, and the routine data will include the routine purchase type 216 that indicates that the user makes this reoccurring purchase when in their home location. As discussed above, rather than including purchases from a particular merchant, the routine purchase type 216 may be associated with purchases from any of a variety of coffee shops, or coffee purchases from anywhere (e.g., the purchase data may indicate that the user purchases a vanilla mocha from a variety of merchants during the time period and at the frequency detailed in the routine purchase type 216.)

In the illustrated embodiment, the home location routine data 214 also includes a routine purchase type 218 that was determined from the purchase data and that details purchases made from similar merchants (“Italian restaurants”) that reoccur at a particular time period (Sunday evenings) once per week. The routine purchase type 218 is not associated with a linked purchase, but is associated with purchase details that detail the types of purchases made when at Italian restaurants (e.g., chicken parmesan 95% of the time, spaghetti with meatballs 80% of the time, Caesar salad 65% of the time, lasagna 50% of the time, red wine 75% of the time, white wine 20% of the time, and tiramisu 35% of the time.) Thus, the user may dine at an Italian restaurant with their family each Sunday night, and the routine data will include the routine purchase type 218 that indicates that the user makes this reoccurring purchase when in their home location. As discussed above, rather than including purchases from similar merchants, the routine purchase type 218 may be associated with purchases from a specific Italian restaurant, or Italian food purchases from anywhere.

In the illustrated embodiment, the home location routine data 214 also includes a routine purchase type 220 that was determined from the purchase data and that details purchases made from a particular merchant (“Yoga Studio A”) that reoccurs at a particular time period (Thursday) once per week. The routine purchase type 220 is associated with a linked purchase from similar merchants (“Ice Cream shop”), and is associated with purchase details that detail the types of purchases made when at the Ice Cream shop (e.g., vanilla ice cream with strawberries 95% of the time, mint chip ice cream 5% of the time.) Thus, the user may attend a yoga class on Thursdays, and may often follow that yoga class with ice cream at any of a plurality of ice cream shops, and the routine data will include the routine purchase type 220 that indicates that the user makes these linked, reoccurring purchases when in their home location. As discussed above, rather than including purchases from a particular merchant, the routine purchase type 220 may be associated with purchases from any of a plurality of yoga studios, and with a particular ice cream shop.

While a plurality of routine purchase types have been described above, one of skill in the art will recognize that a variety of routine purchase types may be determined using purchase data that will fall within the scope of the present disclosure. Furthermore, while the routine data is discussed above as being determined from purchase data associated with the home location, in some embodiments, purchase data associated with any location may be used to determine routine data (e.g., a user's reoccurring purchases in any locations of the same type of items, from the same types of merchants, and/or from particular merchants, may be used to determine the routine purchase types discussed herein.)

Referring back to FIG. 1, the method 100 then proceeds to block 104 where a current location is detected and determined to be over a predetermined distance from the home location. In an embodiment, the user device 202 may include a routine suggestion application or other routine suggestion engine that, when started on the user device 202, automatically retrieves a current location of the user device 202 using a location determination device (e.g, a Global Positioning System (GPS)) in the user device 202. In other embodiments, the routine suggestion application or other routine suggestion engine may operate “in the background” of the user device 202 to periodically check the current location of the user device 202. Upon determination of the current location, the routine suggestion application may determine whether the current location is further than a predetermined distance from the home location. In an embodiment, the predetermined distance may be a default distance in the routine suggestion application (e.g., 100 miles). In other embodiments, the user may set the predetermined distance to a desired distance. In some embodiments, the predetermined distance may operate to confine use of the method 100 to states other than a home state of the user, while in other embodiments, the predetermined distance may operate to provide the method 100 in neighborhoods other than the home neighborhood of the user. In the examples provided below, the current location is Austin, Tex., which is in a different state than the illustrated home location of San Francisco, Calif. However, if the user's home location is in the Nob Hill neighborhood in San Francisco, Calif., the user may set the predetermined distance such that the method 100 is performed in the Noe Valley neighborhood San Francisco, Calif.

When the current location of the user device 202 is determined to over the predetermined distance from the home location, the method 100 then proceeds to block 106 where a current time is determined to correspond to a time period associated with a routine purchase type. In an embodiment, when the current location of the user device 202 is more than the predetermined distance from the home location, the routine suggestion application in the user device 202 may continuously or periodically determine whether a current time is within a predetermined time of any of the time periods associated with the routine purchase types in the database 208. For example, when the current time is within 30 minutes, 1 day, or other time amount of a time period associated with a routine purchase type, the routine suggestion application may determine that the current time corresponds to a time period associated with a routine purchase type. In another example, when the current time falls within a time period associated with a routine purchase type, the routine suggestion application may determine that the current time corresponds to a time period associated with a routine purchase type. The predetermined time may be selected based on a number of factors including, for example, user calendar data that indicates how long a user will be in the current location that is greater than the predetermined distance from the home location. For example, a user calendar may include data that indicates that the user will be in the current location, which is greater than the predetermined distance from the home location, for a week. In such a situation, the routine suggestion application may retrieve each routine purchase type that is associated with that week and provide merchants (discussed below) for those routine purchase types immediately (i.e., the predetermined time may be a week when the user calendar data indicates that the user will be in that current location for a week.)

When the current location of the user device 202 is determined to be over the predetermined distance from the home location, and the current time corresponds to a time period associated with a routine purchase type, the method 100 proceeds to block 108 where merchants are retrieved that are associated with the current location and that provide the routine purchase type. In an embodiment, in response to determining that the current time corresponds to a time period associated with a routine purchase type, the routine suggestion application on the user device 202 may use the routine purchase type and the current location to search (e.g., over a network) a database of merchants in the current location that provide the routine purchase type. For example, if the routine purchase type includes a particular merchant, the routine suggestion application may access, over the network 204, a database of merchants in the current location to see if it includes the particular merchant (e.g., a franchisee) or similar merchants. In another example, if the routine purchase type includes a type of merchant, the routine suggestion application may access, over the network 204, a database of merchants in the current location to see if it includes similar merchants (e.g., the same type of merchant as the particular merchant.) In another example, if the routine purchase type includes an item type, the routine suggestion application may access, over the network 204, a database of merchants in the current location to see if it includes merchants that sell that item. Determination of whether a merchant sells an item or provides a service may be made by searching user reviews for that merchant to determine whether those reviews include mentioned of that item or service, searching online menus provided by that merchant, accessing a merchant database of that merchant that details the items or services for sale, searching other user's purchase histories at that merchant for those items or services, and/or using a variety of other items or service determination methods known in the art.

In an embodiment, merchants retrieved at block 108 may be filtered using the purchase details that are associated with the routine purchase type. For example, the routine purchase type may be a reoccurring purchase at a coffee shop in the home location, and a plurality of coffee shop merchants associated with the current location may be retrieved. Those coffee shop merchants may then be filtered by the item(s) that the user typically purchases at the coffee shop in the home location (e.g., the vanilla mocha in the illustrated embodiment discussed above) by determining which of the retrieved coffee shop merchants in the current location serve those item(s). In one example, the routine purchase type may include an item or items that are associated with a majority of purchases that make up the routine purchase type, and the merchants may be filtered such that only merchants that provide that item or items are displayed at block 110 of the method 100, discussed below. When a plurality of purchase details are associated with the routine purchase type, retrieved merchants that provide more of those purchase details (e.g., items, services, etc.) may be ranked higher than retrieved merchants that do not.

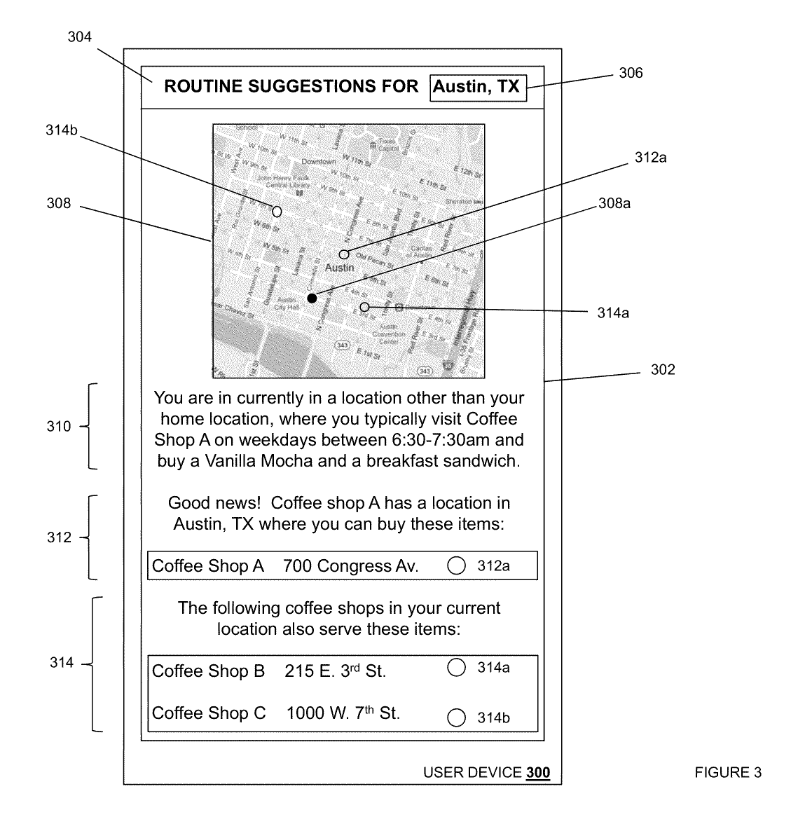

Referring now to FIGS. 1, 2, 3, 4, and 5, the method 100 then proceeds to block 110 where merchants are displayed to the user. Following retrieval of the merchants at block 108 of the method 100, the routine suggestion application on the user device 202 may display those merchants on a display device of the user device 202. FIGS. 3, 4, and 5 below illustrate specific examples of the display of merchants at block 110 of the method 100 following blocks 102, 104, 106, and 108. However, a wide variety of modifications to those examples are envisioned as falling within the scope of the present disclosure.

FIG. 3 illustrates an embodiment of a user device 300 including a display device 302. The display device 302 is displaying a routine suggestion screen 304 for a current location 306 (e.g., “Austin, Tex.”) that is a predetermined distance from a home location, as discussed above. The routine suggestion screen 304 includes a current location map 308 that provides a map of the current location determined at block 104, along with a user indicator 308a that indicates to the user their current location relative to the current location map 308. The routine suggestion screen 304 also includes a routine purchase type indicator 310 that details the routine purchase type associated with the current time determined at block 106. In the illustrated example, the routine purchase type indicator 310 is indicating to the user that, when in their home location, they typically visit Coffee Shop A on weekdays between 6:30-7:30 am and purchase a vanilla mocha and a breakfast sandwich (e.g., items associated with a majority of the purchases in the routine purchase type.)

The routine suggestion screen 304 also includes a first routine purchase suggestion section 312 that details a merchant in the current location that provides the routine purchase type. In the illustrated example, the routine suggestion section 312 has been provided after the routine suggestion application determined that the particular merchant associated with the routine purchase type is located in the current location (e.g., the merchant in the routine suggestion section 312 may be a franchise location related to the particular merchant frequented by the user in the home location.) The routine suggestion section 312 also includes a merchant identifier 312a for the merchant that is displayed on the map 308 to allow the user to determine directions to that merchant (e.g., relative to the user indicator 308a.) The routine suggestion screen 304 also includes a second routine purchase suggestion section 314 that details a plurality of merchants in the current location that provide the routine purchase type. In the illustrated example, the routine suggestion section 314 has been provided after the routine suggestion application has determined that a plurality of similar merchants associated with the routine purchase type are located in the current location (e.g., the merchants in the routine suggestion section 314 are coffee shops in the current location, and may provide items typically purchased by the user according to the routine purchase type.) The routine suggestion section 314 also includes merchant identifiers 314a and 314b for the merchants that are displayed on the map 308 to allow the user to determine directions to those merchants (e.g., relative to the user indicator 308a.)

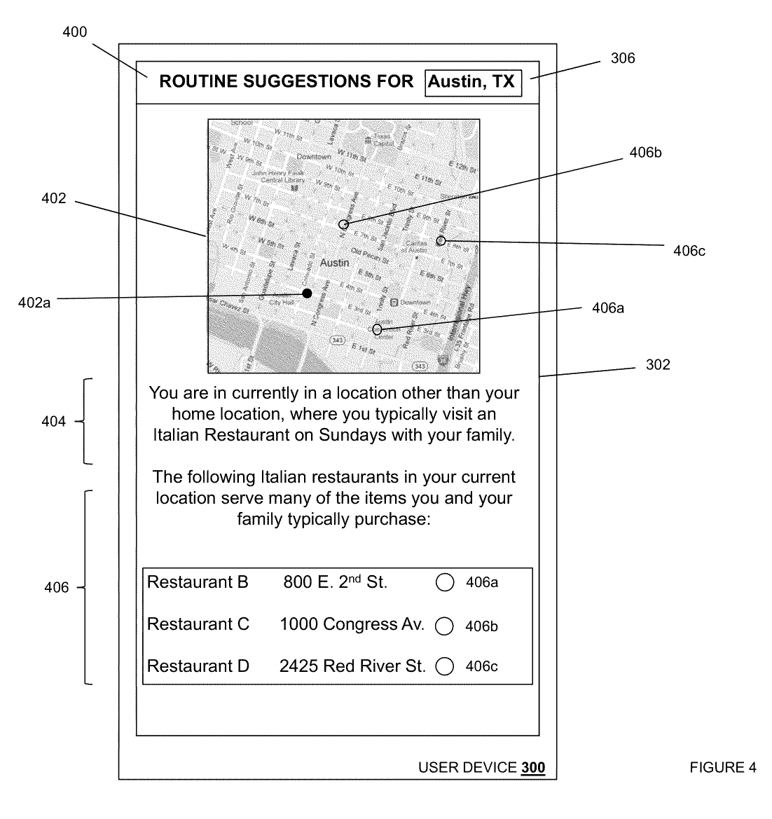

FIG. 4 illustrates an embodiment of the user device 300 with the display device 302 displaying a routine suggestion screen 400 for the current location 306 (e.g., “Austin, Tex.”). The routine suggestion screen 400 includes a current location map 402 that provides a map of the current location determined at block 104, along with a user indicator 402a that indicates to the user their current location relative to the current location map 402. The routine suggestion screen 400 also includes a routine purchase type indicator 404 that details the routine purchase type associated with the current time determined at block 106. In the illustrated example, the routine purchase type indicator 404 is indicating to the user that, when in their home location, they typically visit an Italian restaurant on Sundays with their family (in an embodiment, purchase data may be analyzed to determine that the user visits the Italian restaurant with their family based on, for example, an amount of food ordered, a type of food ordered, etc.)

The routine suggestion screen 400 also includes a routine purchase suggestion section 406 that details merchants in the current location that provide the routine purchase type. In the illustrated example, the routine suggestion section 406 has been provided after the routine suggestion application has determined that a plurality of similar merchants associated with the routine purchase type are located in the current location (e.g., the merchants in the routine suggestion section 406 are Italian restaurants in the current location, and may be filtered and/or ranked by items typically purchased by the user according to the routine purchase type.) The routine suggestion section 406 also includes merchant identifiers 406a, 406b, and 406c for the merchants that are displayed on the map 402 to allow the user to determine directions to those merchants (e.g., relative to the user indicator 402a.)

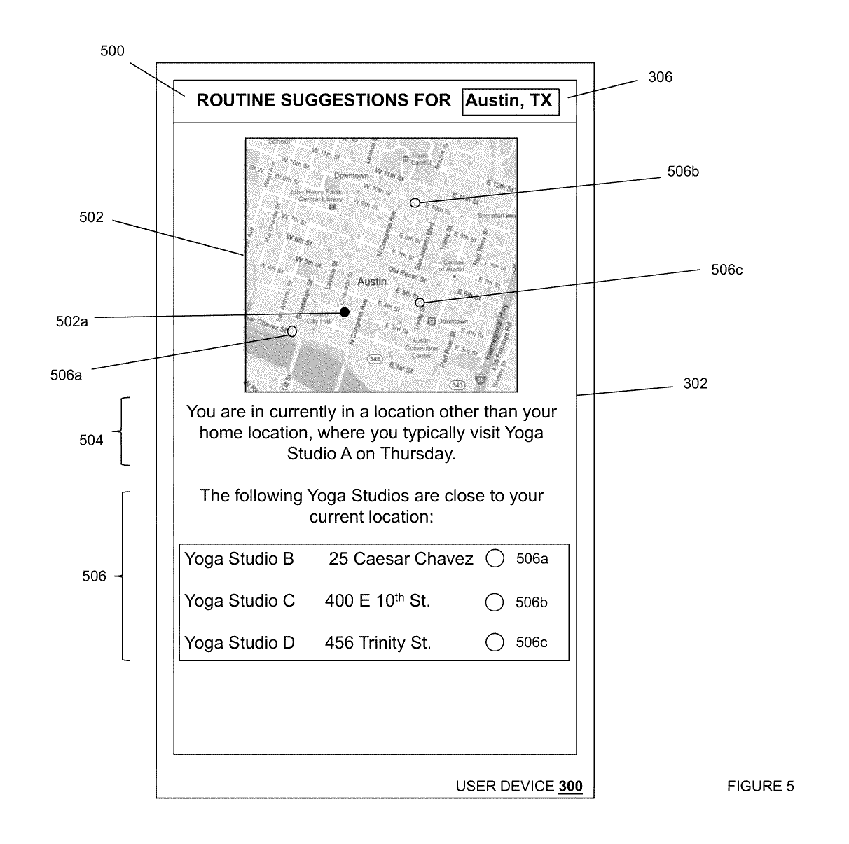

FIG. 5 illustrates an embodiment of the user device 300 with the display device 302 displaying a routine suggestion screen 500 for the current location 306 (e.g., “Austin, Tex.”).

The routine suggestion screen 500 includes a current location map 502 that provides a map of the current location determined at block 104, along with a user indicator 502a that indicates to the user their current location relative to the current location map 502. The routine suggestion screen 500 also includes a routine purchase type indicator 504 that details the routine purchase type associated with the current time determined at block 106. In the illustrated example, the routine purchase type indicator 504 is indicating to the user that they typically visit Yoga Studio A on Thursday.

The routine suggestion screen 500 also includes a routine purchase suggestion section 506 that details merchants in the current location that provide the routine purchase type. In the illustrated example, the routine suggestion section 506 has been provided after the routine suggestion application has determined that a plurality of similar merchants associated with the routine purchase type are located in the current location (e.g., the merchants in the routine suggestion section 506 are yoga studios in the current location.) The routine suggestion section 506 also includes merchant identifiers 506a, 506b, and 506c for the merchants that are displayed on the map 502 to allow the user to determine directions to those merchants (e.g., relative to the user indicator 502a.)

Thus, when the user travels to a location away from their home location, that user may quickly and easily continue to make routine purchases because the systems and methods of the present disclosure learn their routine purchases in the home location and automatically display merchants at which the routine purchases may be made in the location away from the home location.

Following the display of the merchants at block 110, the method 100 may proceed to block 112 where it is determined that a routine purchase type has been made that is associated with a linked purchase type. A user may use the display of merchants at block 110 to select a merchant for making the routine purchase type provided by that merchant, and at block 112 the routine suggestion application may determine that such a routine purchase type has been made. In an embodiment, the routine purchase type may be made using the user device 202, and the routine suggestion application may detect that use and purchase at block 112. In another embodiment, the routine purchase type may be made using another payment device such as a credit card, and details about that transaction may be received by and/or retrieved by the routine suggestion application at block 112. In another embodiment, the routine suggestion application may detect the user is located at the merchant for a predetermined amount of time and, in response, the routine suggestion application may determine that the user has made the routine purchase type (e.g., the routine suggestion application may determine that the user is located at Yoga Studio B, illustrated in FIG. 5, for more than 30 minutes and, in response, determine that the user has made a routine purchase type of a yoga class.)

In response to determining that a routine purchase type has been made, the routine suggestion application may determine (e.g., through communication over the network 204 with the system provider device 206, retrieved from a database in the user device 202, etc.) that the routine purchase is associated with a linked purchase type in the database 208. For example, in the embodiment illustrated in FIGS. 2 and 5, the user may make a routine purchase type from a yoga studio, and the routine suggestion application will determine that the routine purchase type 220 includes a linked purchase type that includes a purchase at an ice cream shop that often follows a purchase of a yoga class.

The method 100 then proceeds to block 114 where linked merchants are retrieved that are associated with the current location and that provide the linked purchase type. In an embodiment, in response to determining that the routine purchase type has been made and is associated with a linked purchase type, the routine suggestion application on the user device 202 may use the linked purchase type and the current location to search a database of merchants in the current location that provide the linked purchase type (e.g., “linked merchants”.) For example, if the linked purchase type includes a particular merchant, the routine suggestion application may access (over the network 204, in the user device 202, etc.) a database of merchants in the current location to see if it includes the particular merchant (e.g., a franchisee) or similar merchants (e.g., the same type of merchant as the particular merchant frequented in the home location.) In another example, if the linked purchase type includes an item type, the routine suggestion application may access (over the network 204, in the user device 202, etc.) a database of merchants in the current location to see if it includes merchants that sell that item.

In an embodiment, linked merchants retrieved at block 114 may be filtered using the purchase details that are associated with the linked purchase type. For example, the linked purchase type may be a reoccurring purchase, which often follows a purchase at a particular yoga studio in the home location, at an ice cream shop in the home location, and a plurality of ice cream shop merchants associated with the current location may be retrieved. Those ice cream shop merchants may then be filtered by the item(s) that the user typically purchases at the ice cream shop in the home location (e.g., the vanilla ice cream with strawberries in the illustrated embodiment discussed above) by determining which of the retrieved ice cream shop merchants in the current location serve those item(s). In one example, the linked purchase type may include an item or items that are associated with a majority of purchases that make up the linked purchase type, and the merchants may be filtered such that only merchants that provide that item or items are displayed at block 110 of the method 100, discussed below.

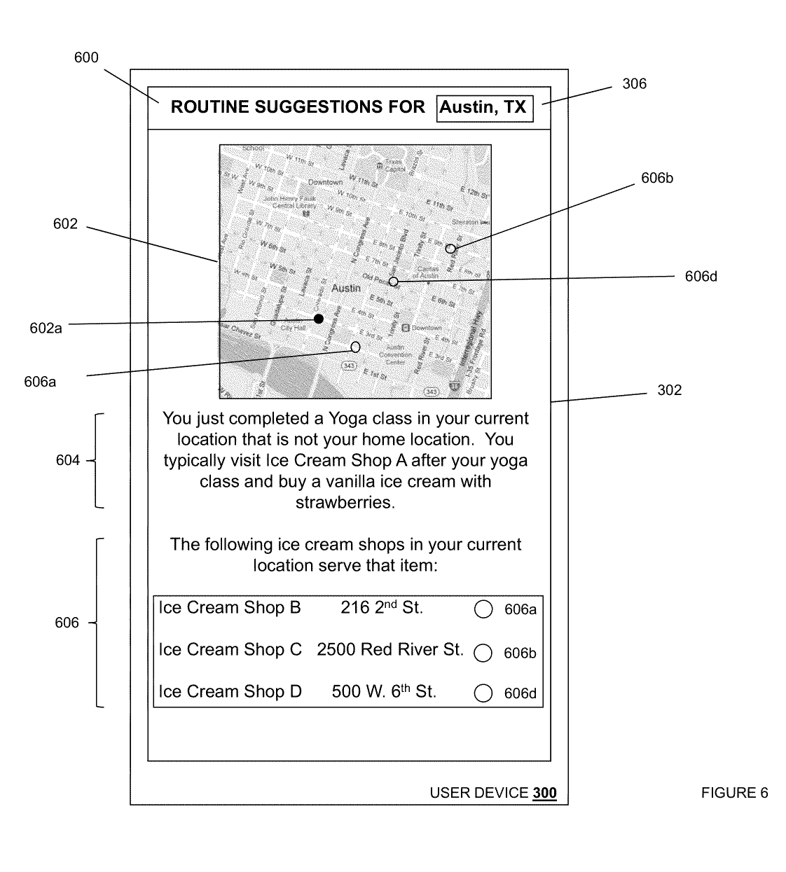

Referring now to FIGS. 1, and 6, the method 100 then proceeds to block 116 where linked merchants are displayed to the user. Following retrieval of the linked merchants at block 114 of the method 100, the routine suggestion application may display those linked merchants on a display device of the user device 202. FIG. 6, with reference to FIG. 5 discussed above, illustrates a specific example of the display of linked merchants at block 116 following blocks 112 and 114 of the method 100. However, a wide variety of modifications to that example are envisioned as falling within the scope of the present disclosure.

FIG. 6 illustrates an embodiment of the user device 300 with the display device 302 displaying a routine suggestion screen 600 for the current location 306 (e.g., “Austin, Tex.”) following the determination that a purchase was made at a merchant displayed on the routine suggestion screen 500, discussed above with reference to FIG. 5. The routine suggestion screen 600 includes a current location map 602 that provides a map of the current location determined at block 104, along with a user indicator 602a that indicates to the user their current location relative the current location map 602. The routine suggestion screen 600 also includes a linked purchase type indicator 604 that details the linked purchase type determined at block 112. In the illustrated example, the linked purchase type indicator 604 is indicating to the user that, when in the home location, they typically visit Ice Cream Shop A after attending a yoga class and purchase a vanilla ice cream with strawberries (e.g., an item associated with a majority of the purchases in the routine purchase type.)

The routine suggestion screen 600 also includes a linked purchase suggestion section 606 that details merchants in the current location that provide the linked purchase type. In the illustrated example, the linked purchase suggestion section 606 has been provided after the routine suggestion application has determined that a plurality of similar merchants associated with the linked purchase type are located in the current location (e.g., the merchants in the routine suggestion section 606 are ice cream shops in the current location.) The linked purchase suggestion section 606 also includes merchant identifiers 606a, 606b, and 606c for the merchants that are displayed on the map 602 to allow the user to determine directions to those merchants (e.g., relative to the user indicator 602a.) In different embodiments, any number of linked purchase types may be associated with a routine purchase type or other linked purchase types.

Thus, systems and methods have been described that provide routine suggestions to a user by first determining routine purchase types of the user that include reoccurring purchases that occur during reoccurring time periods in a home location. When the user travels to a different location that is away from the home location, the systems and methods discussed herein may provide the locations of merchants in that different location that provide the routine purchase type so that the user may continue to make those routine purchase types during their usual time periods. Routine purchase types may be associated with any number of linked purchase types that include purchases that are often made in association with a routine purchase type, and following the determination that a routine purchase type has been made, the location of merchants that provide the linked purchase type may be provided to the user. Thus, a user's routine may be uninterrupted when that user is away from their usual location through the learning of those routines and the suggestions of merchants in different locations at which those routines may be conducted.

The present disclosure also provides systems and methods for providing user routine suggestions by identifying user routines (which may or may not be associated with purchases) and allowing users to provide details about those identified user routines such that routine suggestions for those identified user routines focus on the attributes of those routines that are the most important to the user. A user may generate a plurality of user activity data in a home location area by sending, via their user device while performing activities at a plurality of different times, their current location, the current time, and in some embodiments, a variety of information about the current location such as, for example, current temperature, location attributes, etc. For example, a user may regularly frequent parks, go on bike rides on the weekends, and go to swimming areas during the summer. In some embodiments, the user may precede or follow those user activities with a purchase or other activity. The location data associated with those user activities may be stored and analyzed to identify user routines that are associated with the home location area of the user and that may detail repetitive user activities by the user by associating routine locations of the user with particular time periods. The identified user routines may then be presented to the user for confirmation and customization by, for example, allowing the user to rank attributes or provide user criteria of locations associated with the identified user routines.

When the user travels to a different location (a “current location area”) that is more than a predetermined distance from the home location area, the systems and methods may determine that a current time corresponds to a time period associated with the identified and confirmed routine and, in response, retrieve locations that are located in the current location area and that include attributes according to the user provided rankings or criteria. Those locations may then be displayed on a user device to allow the user to quickly and easily determine a location in their current location area (away from their home location) at which they may perform their routine. User activity data may include linked purchases that are purchases commonly made by the user subsequent to or following the user being in a routine location or location type in the home location area, and the systems and methods may retrieve merchants that are located in the current location area and that provide those types of purchases when providing the locations associated with the routine.

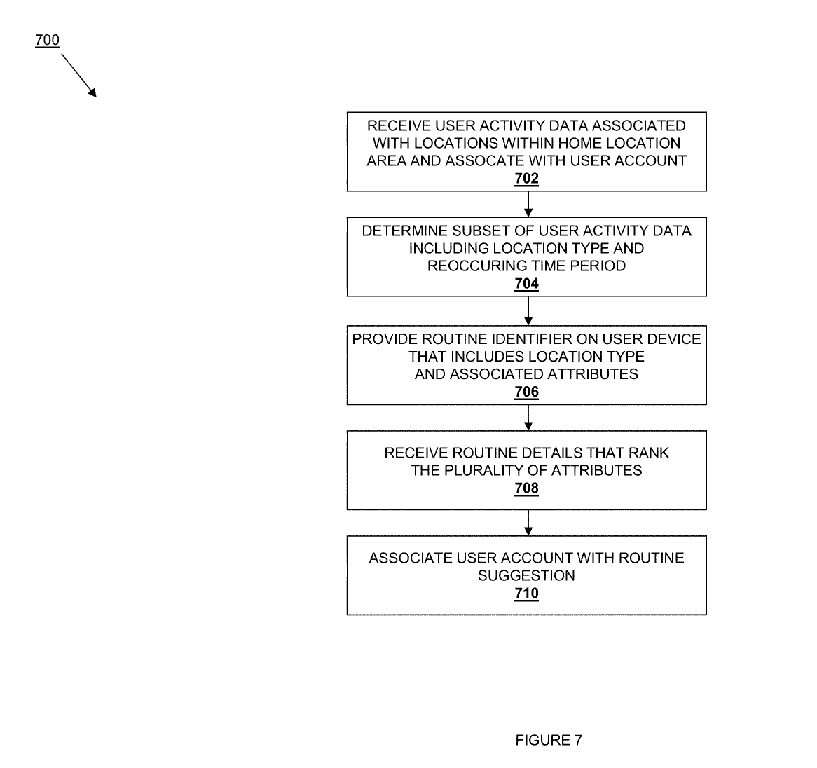

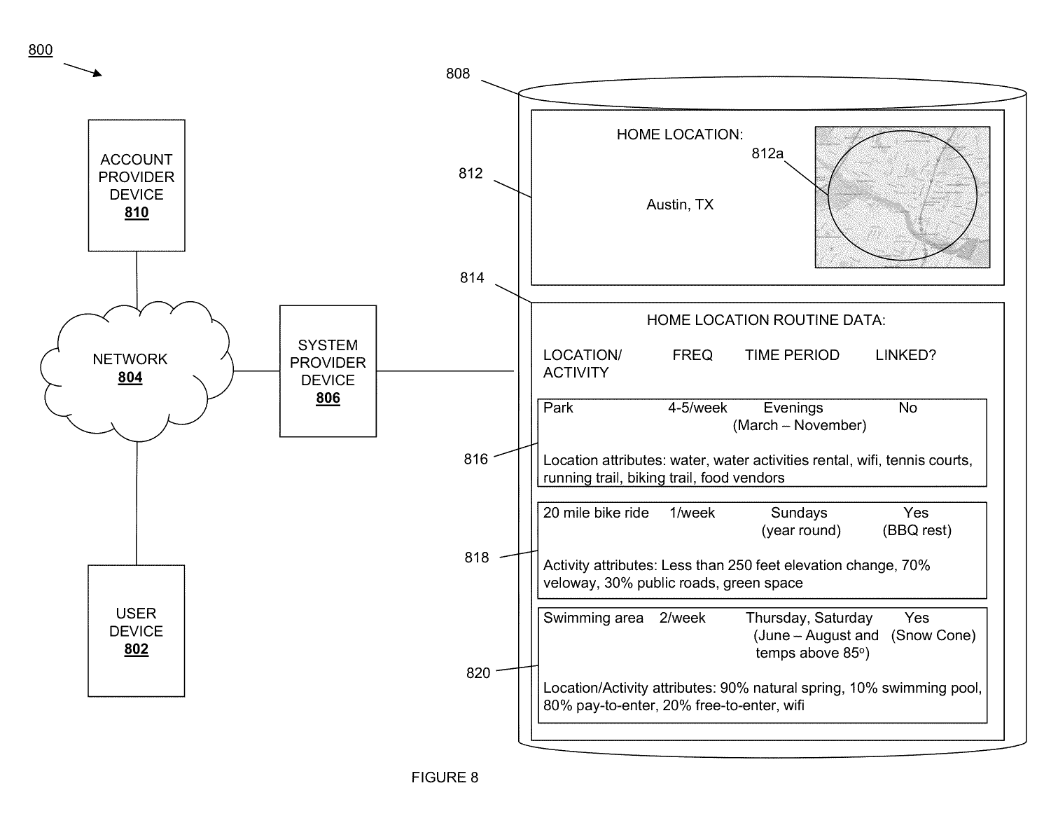

Referring now to FIGS. 7 and 8, an embodiment of a method 700 for providing routine suggestions is illustrated. As discussed above, in an embodiment, a user may be provided a user account by a payment service provider, and that user account will be linked to one or more financial accounts of the user that are provided by account providers. The user may make purchases from merchants using the user account, and those purchases are funded using one of the financial accounts. Thus, in some embodiments, the payment service provider may be the routine suggestion system provider. However, in other embodiments, the routine suggestion system may be provided by an account provider that provides a financial account to the user, or any third party system provider that may retrieve purchase data from user accounts/financial accounts, and/or user activity data associated with locations, times, and attributes of the locations.

The method 700 begins at block 702 where user activity data is received that is associated with locations within a home location area, and that user activity data is associated with a user account. Referring now to FIG. 8, an embodiment of a routine suggestion system 800 is illustrated. A user in the routine suggestion system 800 may include a user device 802 that is connected to a network 804 such as, for example, the Internet. A system provider device 806 is connected to the network 804 as well as to a database 808. While the system provider device 806 is illustrated as directly connected to the database 808, the system provider device 806 may be connected to the database 808 through the network 804 while remaining within the scope of the present disclosure.

In an embodiment, at block 702 of the method 700, the user may perform user activities that include going to different locations that are determinable and reportable by user device 802, and in some embodiments making purchases from merchants using the user device 802 and/or other payment devices. The details with regard to purchase data in the systems and methods discussed herein are discussed extensively with regard to the method 100 above, and thus are repeated here. As such, the method 700 is discussed below primarily with regard to user activity data that does not necessarily involve a purchase, but combinations including user activity data and purchase data are envisioned as being within the scope of the present disclosure, as described in some of the examples given below.

In one example of block 702, the user device 802 may include a mobile phone, and the mobile phone may include a routine determination and suggestion application that operates to periodically determine user activity data that may include the location of the user device 802 (e.g., using a location determination device in the user device 802), attributes associated with that location (e.g., retrieved by the user device 802 over the Internet), a current time, the temperature at the location (e.g., using a temperature determination device in the user device 802, retrieved by the user device 802 over the Internet), and/or a variety of other user activity information known in the art. The user activity data received from the user device 802 may then be stored in the database 808 in association with the user of the user device 802. For example, when the system provider device 806 is operated by a system provider that provides the financial account used by the user to make purchases, user activity data and/or purchase data may be stored by the system provider device 806 in the database 808. In another example, purchase data may be stored by an account provider device 810 in a database (not illustrated), and the system provider device 806 may then periodically retrieve that purchase data and store that purchase data (along with received user activity data) in the database 808. In another embodiment, the user device 802 may be the system provider device 806 and may retrieve and store the user activity data and/or the purchase data from financial institutions of the user. Thus, in some embodiments, the database 808 may be located in the user device 802.

User activity data may be associated with a home location area. In an embodiment, a user may define a home location area where the user typically performs user activities (e.g., the location in which the user lives or spends a majority of their time), and that home location area may then be saved as home location area data 812 in the database 808. In the example illustrated in FIG. 8, the home location data corresponds to an area 812a in Austin, Tex. The user may define the home location area by selecting the area 812a on a map, providing a home address and a distance from that home address within which user activities will be associated with the home location area, providing a city (e.g., Austin, Tex.) in which user activities will be associated with the home location, and/or performing a variety of other home location area designation actions known in the art. In another embodiment, user activity data may be analyzed to determine a home location area. For example, the system provider device may review all user activity data retrieved at block 702 of the method 700, and determine an area within which over a predetermined percentage of user activities are performed. In the example illustrated in FIG. 8, the user activity data associated with the user may have been analyzed (e.g., user activities of the user device 202 that are associated with a GPS location) and determined to include 85% user activities performed within the area 812a in Austin, Tex. While a few examples of the determination of a home location area for a user have been described, one of skill in the art will recognize that a variety of other methods may be used to determine a home location area where a user performs the majority of their user activities.

The method 700 may then proceed to block 704, where the received user activity data that is associated with the user account in the database is analyzed to determine a subset of the user activity data that includes a location type and a reoccurring time period. In an embodiment, the user activity data associated with locations within the home location area is analyzed to determine a location type for a subset of the user activity data that occurs during common time periods. For example, the user activity data associated with locations within the home location area may be analyzed to determine user activities in a particular location (having a location type) that reoccurs (e.g., that are performed daily, weekly, monthly, etc.) In another example, the user activity data associated with locations within the home location area may be analyzed to determine user activities in locations that are associated with a common location type (e.g., each of those locations is the same type of location) and that reoccur (e.g., that are performed daily, weekly, monthly, etc.) In another embodiment, the user activity data associated with location(s) within the home location area may be analyzed to determine user activities in location(s) that reoccur seasonally or during particular weather periods (e.g., summertime, wintertime, below certain temperatures, above certain temperatures, in particular temperature ranges, etc.) The analysis of the user activity data associated with locations within the home location area at block 702 of the method 700 results in the identification of a routine for the home location area that details reoccurring user activity by the user associated with a location type.

Furthermore, user activity data may include or be associated with attributes of each location associated with the identified routine, and those attributes may be associated with the identified routine for the home location area in the database 808. For example, an identified routine for the home location area may include reoccurring user activities associated with one or more locations having a location type or common location type (e.g., a park or parks), along with attributes about those location(s) (e.g., that the park(s) include water, water activity rentals, WiFi, tennis courts, running trails, biking trails, food vendors, etc.)

The analysis of the user activity data at block 102 of the method 100 may also include the determination of linked purchases that are associated with the identified routine. As discussed above, the purchase data associated with the home location area may be analyzed to determine one or more routine purchase types that that are each associated with reoccurring time periods. For an identified routine, the system provider device 206 may analyze the purchase data to determine whether a linked purchase is commonly made prior to or following the user activity associated with that identified routine. In an embodiment, a user may make reoccurring purchases (e.g., from a particular merchant, from similar merchants, or of similar items) subsequent to or following the user activity associated with the identified routine. For example, the system provide device 206 may analyze the purchase data to determine a routine purchase type that involves a particular merchant during a reoccurring time period is made 65% of the time following a particular user activity, and that linked purchase type may be associated with the identified routine in the database 808.

Examples of identified routines determined from the analysis of the user activity data at block 702 of the method 700 are illustrated in FIG. 8. In the illustrated embodiment, a plurality of home location identified routines 814 are categorized by a location/activity, a frequency, a time period, and whether that identified routine is associated with a linked purchase type. However, identified routines may be categorized by and/or include a variety of other information known in the art that is associated with user activity data without departing from the scope of the present disclosure.

In the illustrated embodiment, the home location identified routines 814 includes an identified routine 816 that was determined from the user activity data and that details user activity at a location or locations with a location type (a park) that reoccurs at a particular time period (evenings between the months of March and November) multiple times per week (4-5 time per week). The identified routine 816 is not associated with a linked purchase, but is associated with location attributes that detail features of the location(s) (e.g., the user has visited parks that include water, water activities rental, WiFi, tennis courts, running trails, biking trails, and food vendors in the illustrated embodiment) that resulted in the identified routine 816. Thus, the user may visit a park or parks in their home location area in the evenings on weekdays between the months of March and November, and the analysis of the user activity data associated with those activities will result in the identified routine 816 that indicates that the user performs this reoccurring user activity when in their home location area.

In the illustrated embodiment, the home location identified routines 814 includes a identified routine 818 that was determined from the user activity data and that details user activity at a location or locations with a location type (a 20 mile bike ride on roads) that reoccurs at a particular time period (Sundays year round) once per week. The identified routine 816 is associated with a linked purchase from a type of merchant (BBQ restaurants), and is also associated with attributes that detail features of the activity or location(s) (e.g., the user typically goes on 20 mile bike rides that include less than 250 foot of elevation change, 70% veloway roads, 30% public roads, and green space in the illustrated embodiment) that resulted in the identified routine 818. Thus, the user may regularly go on a 20 mile bike ride on Sundays, often followed by a meal at a barbeque restaurant, and the analysis of the user activity data associated with those activities will result in the identified routine 818 that indicates that the user performs this reoccurring user activity when in their home location area.

In the illustrated embodiment, the home location identified routines 814 includes a identified routine 820 that was determined from the user activity data and that details user activity at a location or locations with a location type (a swimming area) that reoccurs at a particular time period (Thursdays and Sundays between June and August) and/or in particular temperature ranges (when the temperature is above 85°). The identified routine 820 is associated with a linked purchase from a type of merchant (Snow Cone Vendors), and is also associated with attributes that detail features of the activity or location(s) (e.g., the user has visited parts that include 90% natural springs, 10% swimming pools, 80% pay-to-enter, 20% free-to-enter, and WiFi in the illustrated embodiment) that resulted in the identified routine 820. Thus, the user may regularly visit a swimming area on Thursdays and Sundays during the summer or when it is hot out, often followed by a purchase at from a snow cone vendor, and the analysis of the user activity data associated with those activities will result in the identified routine 820 that indicates that the user performs this reoccurring user activity when in their home location area.

While a plurality of identified routines have been described above, one of skill in the art will recognize that a variety of identified routines may be determined using user activity data and, in some embodiments, purchase data, that will fall within the scope of the present disclosure. Furthermore, while the identified routines are discussed above as being determined from user activity data associated with the home location area, in some embodiments, user activity data associated with any location may be used to identify routines (e.g., a user's reoccurring user activity in any location may be used to identify routines as discussed herein.)

Referring back to FIG. 7, the method 700 then proceeds to block 706 where a routine identifier, which includes the location type and associated attributes of the routine identified in block 704, is provided for display on the user device. In one embodiment, blocks 702 and 704 may be performed by the system provider device 806, and the routine identifier may be provided to the user device 802 over the network. In another embodiment, blocks 702 and 704 may be performed by the user device 802, and the routine identifier may be provided by the user device 806 on its display.

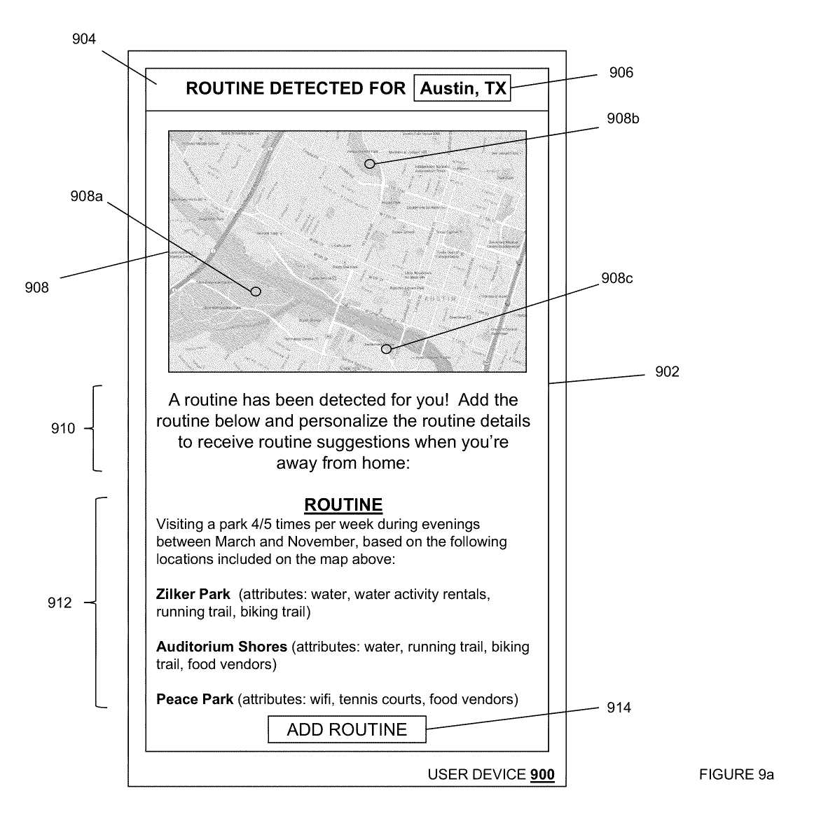

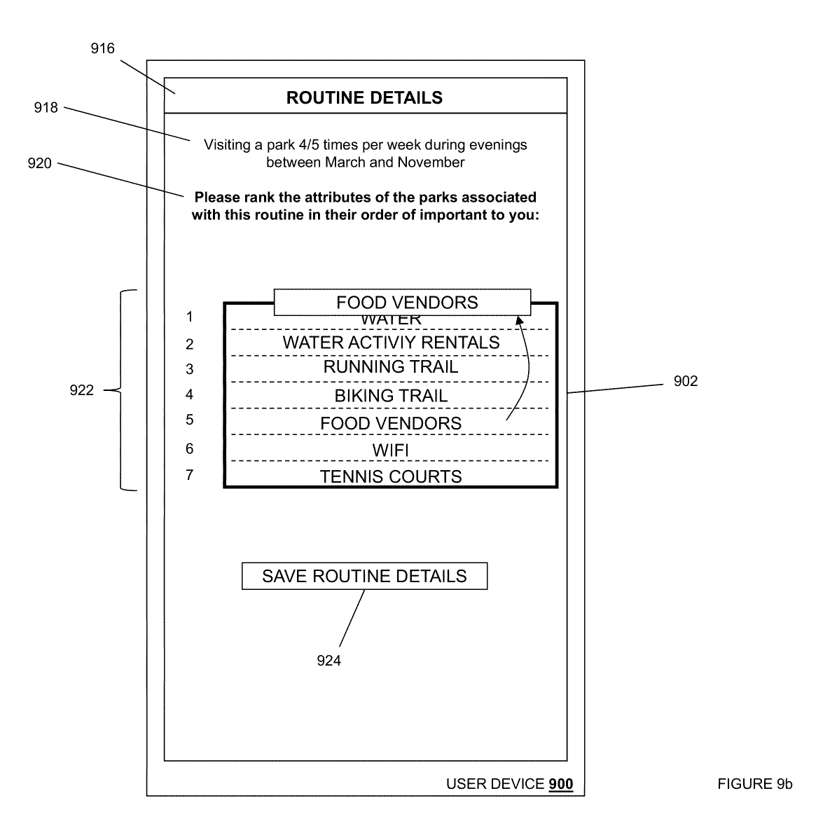

FIGS. 9a, 10a, and 11a below illustrate specific examples of the display of routine identifiers at block 706 of the method 700. However, a wide variety of modifications to those examples are envisioned as falling within the scope of the present disclosure.

FIG. 9a illustrates an embodiment of a user device 900 including a display device 902. The display device 902 is displaying a routine identifier 904 for a routine identified in a home location area 906 (e.g., “Austin, Tex.”) of the user of the user device 900. The routine identifier 904 includes a home location area map 908 that provides a map of the home location area, along with location indicators 908a, 908b, and 908c that indicate to the user the locations associated with the identified routine that resulted in the routine identifier 904. The routine identifier 904 also includes a routine identifier instruction 910 that informs the user that a routine has been identified that may be further customized or personalized (e.g., by the user providing the routine details discussed below.) The routine identifier 904 also includes an identified routine section 912 that includes details about the identified routine that resulted in the routine identifier 904.

In the example in FIG. 9a, the identified routine section 912 is indicating to the user that a routine has been identified in their home location area that includes visiting a park 4 to 5 times per week during the evenings between March and November. In one embodiment, the system provider device may have previously received user activity data that included location data corresponding to the location indicators 908a, 908b, and 908c, and that location data may have been received primarily during the evenings (e.g., 85% of location data received that was determined to correspond to a park location type was received past 5 pm), distributed across the different days of the week (e.g., no location data received for any particular day of the week hit a predetermined percentage that would distinguish that day of the week from others), and primarily between the months of March and November (e.g., 75% of location data received that was determined to correspond to a park location type was received between March 1^{st} and November 30^{th}). The identified routine section 912 includes details about the locations that resulted in the identified routine. For example, in the illustrated embodiment, the identified routine section 912 includes a park (e.g., Zilker Park) associated with the location indicator 908a and including attributes (e.g., water, water activities rental, running trail, biking trail) of that park, a park (e.g., Auditorium Shores) associated with the location indicator 908c and including attributes (e.g., water, running trail, biking trail, food vendors) of that park, and a park (e.g., Peace Park) associated with the location indicator 908b and including attributes (e.g., WiFi, tennis courts, food vendors) of that park.

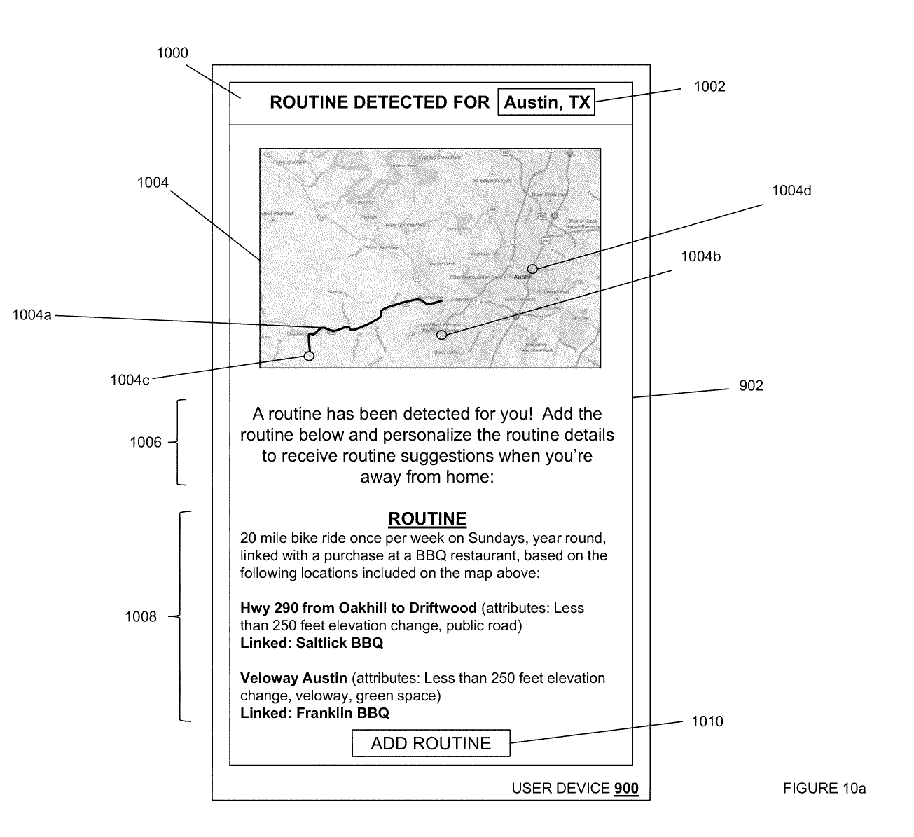

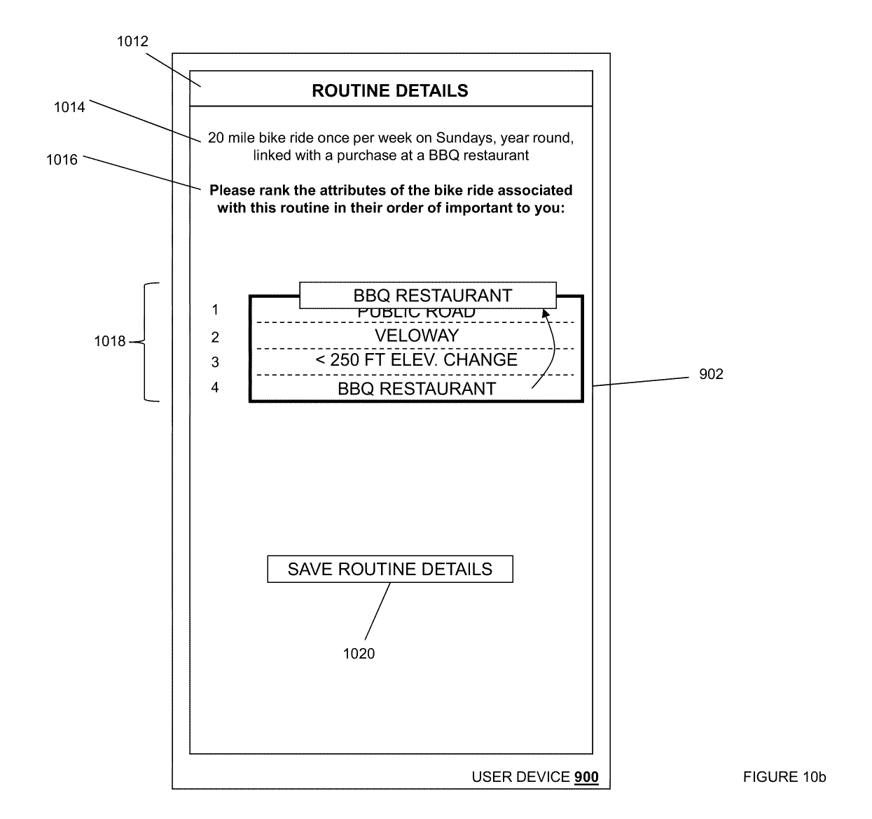

FIG. 10a illustrates an embodiment of the user device 900 with the display device 902 displaying a routine identifier 1000 for a routine identified in a home location area 1002 (e.g., “Austin, Tex.”) of the user of the user device 900. The routine identifier 1000 includes a home location area map 1004 that provides a map of the home location area, along with location indicators 1004a, 1004b, 1004c, and 1004d that indicate to the user the activities and/or locations associated with the identified routine that resulted in the routine identifier 1000. The routine identifier 1000 also includes a routine identifier instruction 1006 that informs the user that a routine has been identified that may be further customized or personalized (e.g., by the user providing the routine details discussed below.) The routine identifier 1000 also includes an identified routine section 1008 that includes details about the identified routine that resulted in the routine identifier 1000.

In the example illustrated in FIG. 10a, the identified routine section 1008 is indicating to the user that a routine has been identified in their home location area that includes a 20 mile bike ride once per week on Sundays, year round. In one embodiment, the system provider device may have previously received user activity data that included location data corresponding to the location indicators 1004a, 1004b, 1004c, and 1004d, and that location data may have been received primarily on Sundays (e.g., 90% of location data received that was determined to correspond to a biking location type (e.g., a bike track) or a bike ride (e.g., a plurality of location data indicating that the user's movement was consistent with a bike ride on a road—for example, movement for 20 miles at approximately 25 miles per hour on a road with a speed limit of 55 miles per hours) was received on Sundays), distributed across the different months of the year (e.g., no location data received for any particular Sunday in any given month hit a predetermined percentage that would distinguish that month from others), and routinely followed by a purchase at a BBQ restaurant (e.g., 80% of the time location data was received that was determined to correspond to a biking location type or a bike ride, that was followed by purchase data corresponding to a BBQ restaurant.) The identified routine section 1008 includes details about the activities and/or locations that resulted in the identified routine. For example, in the illustrated embodiment, the identified routine section 1008 includes a road (e.g., Hwy 290 from Oakhill to Driftwood) associated with the location indicator 1004a (e.g., determined from a plurality of location data indicating the user regularly bikes along that road) and including attributes (e.g., less than 250 feet elevation change, public road) of that road and a linked purchase (e.g., a BBQ purchase from Saltlick BBQ that is linked to the 20 mile bike ride on Hwy 290 from Oakhill to Driftwood) associated with the location indicator 1004c (e.g., a merchant location), and a location (e.g., Veloway Austin) associated with the location indicator 1004b and including attributes (e.g., less than 250 feet elevation change, veloway, green space) of that location and a linked purchase (e.g., a BBQ purchase from Franklin BBQ that is linked to the 20 mile bike ride Veloway Austin) associated with the location indicator 1004d.

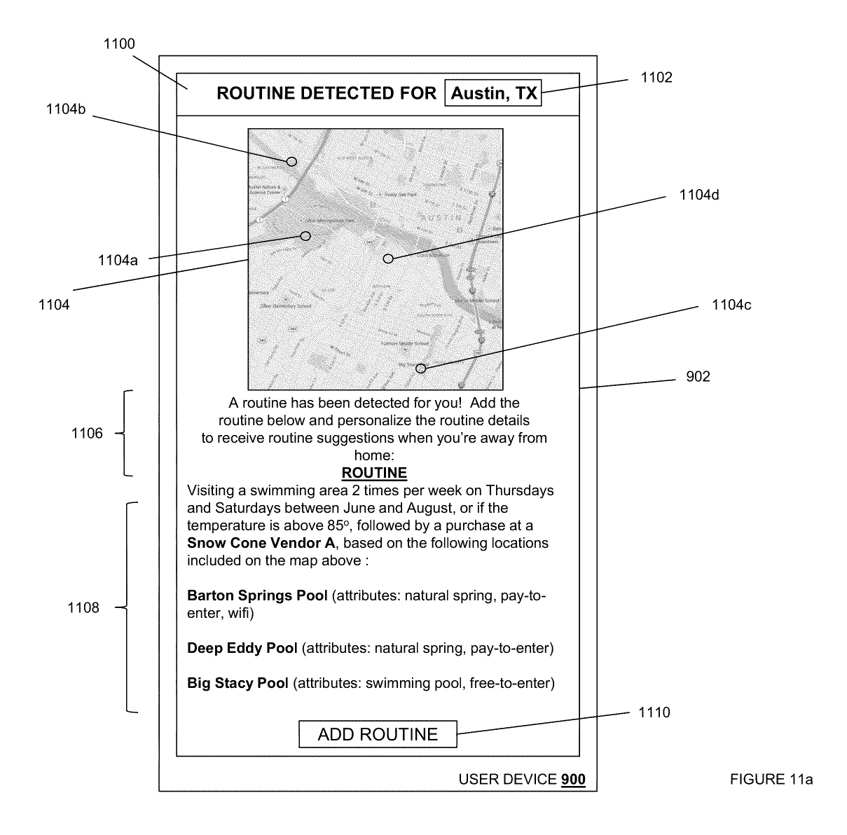

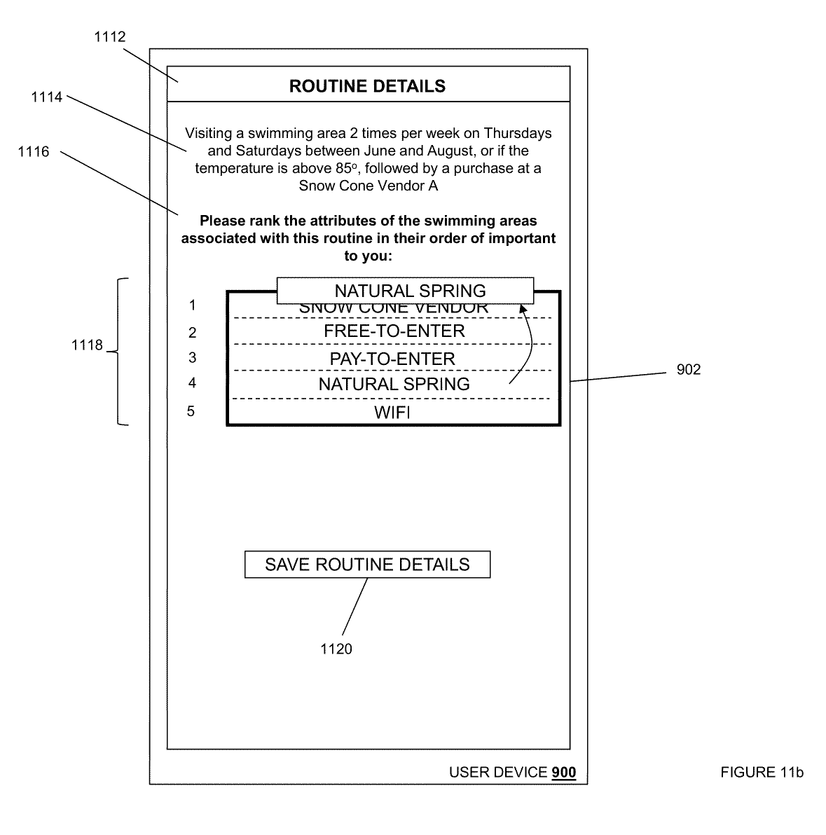

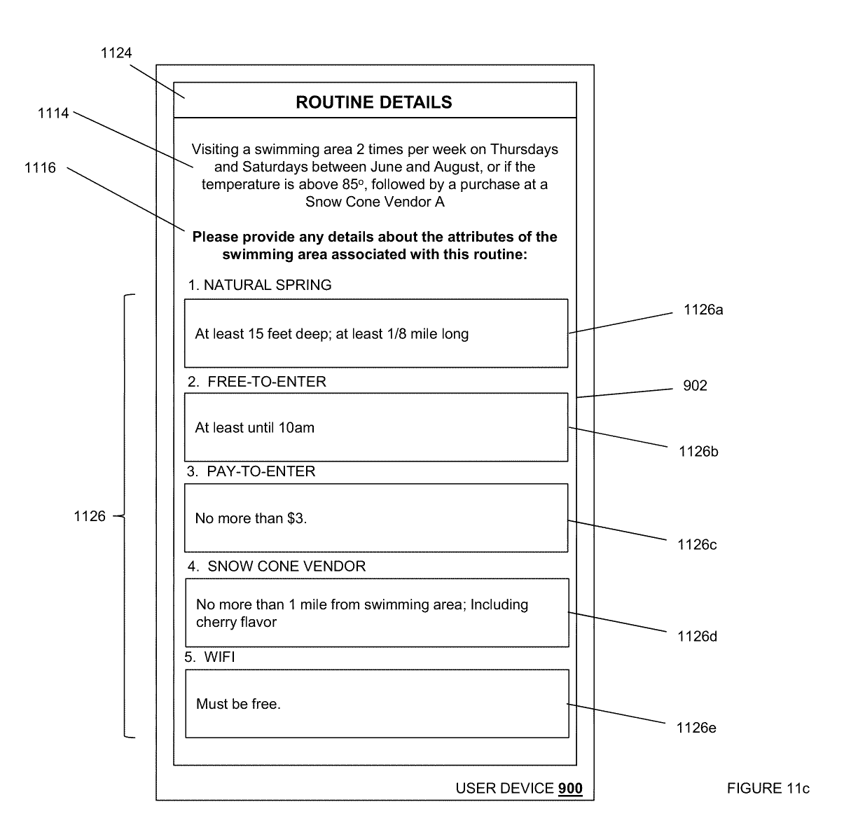

FIG. 11a illustrates an embodiment of the user device 900 with the display device 902 displaying a routine identifier 1100 for a routine identified in a home location area 1102 (e.g., “Austin, Tex.”) of the user of the user device 900. The routine identifier 1100 includes a home location area map 1104 that provides a map of the home location area, along with location indicators 1104a, 1104b, 1104c, and 1104d that indicate to the user the locations associated with the identified routine that resulted in the routine identifier 1100. The routine identifier 1100 also includes a routine identifier instruction 1106 informs the user that a routine has been identified that may be further customized or personalized (e.g., by the user providing the routine details discussed below.) The routine identifier 1100 also includes an identified routine section 1108 that includes details about the identified routine that resulted in the routine identifier 1100.

In the example illustrated in FIG. 11a, the identified routine section 1108 is indicating to the user that a routine has been identified in their home location area that includes visiting a swimming area 2 times per week on Thursdays and Saturdays either between June and August or when the temperature is above 85°, followed by a linked purchase at a particular merchant (e.g., Snow Cone Vendor A associated with location indicator 1104d in the illustrated embodiment.) The identified routine section 1108 includes details about the locations that resulted in the identified routine. In one embodiment, the system provider device may have previously received user activity data that included location data corresponding to the location indicators 1104a, 1104b, 1104c, and 1104d, and that location data may have been received primarily on Thursdays and Saturdays between June and August or when the temperature was over 85° (e.g., 75% of location data received that was determined to correspond to a swimming area was received on Thursdays and Saturdays, either between the months of June and August, or outside those months but only when the temperature exceeded 85°), and routinely followed by a purchase at a particular snow cone vendor (e.g., 95% of the time location data was received that was determined to correspond to a swimming area, that was followed by purchase data corresponding to Snow Cone Vendor A.) For example, in the illustrated embodiment, the identified routine section 1108 includes a swimming area (e.g., Barton Springs Pool) associated with the location indicator 1104a and including attributes (e.g., natural spring, pay-to-enter, WiFi) of that swimming area, a swimming area (e.g., Deep Eddy Pool) associated with the location indicator 1104b and including attributes (e.g., natural spring, pay-to-enter) of that swimming area, a swimming area (e.g., Big Stacy Pool) associated with the location indicator 1004c and including attributes (e.g., swimming pool, free-to-enter) of that swimming area. Location indicator 1004d indicates the location of the merchant (Snow Cone Vendor A) that is associated with the purchase data that routinely follows visits to the swimming areas.

While a few examples of how routines are identified and reported to a user have been provided above, a wide variety of modification to such identification and reporting is envisioned as falling within the scope of the present disclosure. For example, many of the examples of the identified routines are discussed above as being identified based on location data associated with a particular location type being received in a quantity that is over a predetermined percentage of the total location data received that is associated with that particular location type. However, any criteria may be used to identify a routine from location data associated with a particular location type including, but not limited to, a predetermined number of visits to a particular location type, visits to a particular location type in a predetermined frequency amount that is greater than other users of the system, etc.

Using any of the routine identifiers 904, 1000, or 1100 illustrated in FIGS. 9a, 10a, and 11a, respectively, the user may send a routine confirmation to confirm the identified routine (e.g., by selecting the ADD ROUTINE buttons 914, 1010, or 1110 on the routine identifiers 904, 1000, or 1100, respectively.) Thus, if a user receives a routine identifier at block 706 that describes a routine of the user that the user wishes to continue when away from their home location area, the user may send a routine confirmation to confirm the details of the identified routine and instruct the system provider device to perform the routine suggestion, discussed above with reference to the method 100, when the user is away from the home location area.

The method 100 then proceeds to block 708 where routine details are received that rank the plurality of attributes associated with the identified routine. As discussed below, in confirming an identified routine (e.g., either prior or subsequent to the confirming discussed above), the user may provide information about the routine, attributes associated with the routine, and/or any other routine information known in the art such that routine suggestions by the system provider device provide locations with particular attributes desired by the user when the user is away from their home location area.

FIGS. 9b, 10b, 11b, and 11c below illustrate specific examples of the display of routine details screens at block 708 of the method 700 that allow a user to provide routine details about an identified and/or confirmed routine. However, a wide variety of modifications to those examples are envisioned as falling within the scope of the present disclosure.

FIG. 9b illustrates an embodiment of the user device 900 with the display device 902 displaying a routine details screen 916 for an identified or confirmed routine (e.g., the routine confirmed as discussed above with reference to FIG. 9a.) The routine details screen 916 includes a description 918 of the confirmed routine (e.g., visiting a park 4 to 5 times per week during evenings between March and November), a routine details request 920 that requests the user to provide routine details (e.g., by ranking attributes of the locations in the home location area that are associated with the identified or confirmed routine), and a routine details provision section 922. In the illustrated embodiment, the routine details provision section 922 includes a user adjustable ranking table that includes each of the attributes associated with the locations that resulted in the identified routine on the routine identifier 904 in FIG. 9a. In the illustrated embodiment, the user adjustable ranking table includes the attributes of the parks included in the routine details section 912 on the routine identifier 904, and the user may order the attributes provided in the user adjustable ranking table (by dragging and dropping the attributes using an input device on the user device 900 as illustrated) into ranked positioned (e.g., ranked positions 1-7 provided on the user adjustable ranking table in the illustrated embodiment) to indicate to the system provider device the relative important of the attributes of the locations with regard to the identified or confirmed routine. The user may then select the save routine details button 924 to save the routine details provided in the routine details provision section 922

In a specific example, the user may confirm that they have a routine in which they visit a park 4 to 5 times per week during evenings between March and November, and then may use the user adjustable ranking table in the routine details provision section 922 to rank the attributes as follows: 1. Food vendors, 2. WiFi, 3. Water, 4. Water activity rentals, 5. Tennis courts, 6., Running trail, and 7. Biking trail. Such rankings may be provided to inform the system provider device that, when away from their home location area and during evenings between March and November, routine recommendations for parks to visit should prioritize parks having food vendors and WiFi (e.g., over running trails and biking trails.) Thus, the user may rank attributes associated with a location type in an identified or confirmed routine so the routine recommendations for those identified or confirmed routines provide locations that have the most desirable attributes as defined by the user.

FIG. 10b illustrates an embodiment of the user device 900 with the display device 902 displaying a routine details screen 1012 in response to an identified or confirmed routine (e.g., the routine confirmed as discussed above with reference to FIG. 10a.) The routine details screen 1012 includes a description 1014 of the identified or confirmed routine (e.g., 20 mile bike ride once per week on Sundays, year round, linked with a purchase at a BBQ restaurant), a routine details request 1016 that requests the user to provide routine details (e.g., by ranking attributes of the activity/locations in the home location area that are associated with the identified or confirmed routine), and a routine details provision section 1018. In the illustrated embodiment, the routine details provision section 1018 includes a user adjustable ranking table that includes each of the attributes associated with the activity/locations that resulted in the identified routine and linked purchase on the routine identifier 1000 in FIG. 10a. Thus, in the illustrated embodiment, the user adjustable ranking table includes the attributes of the 20 mile bike rides included in the routine details section 1008 on the routine identifier 1000, and the user may order the attributes provided in the user adjustable ranking table (by dragging and dropping the attributes using an input device on the user device 900 as illustrated) into ranked positioned (e.g., ranked positions 1-4 provided on the user adjustable ranking table in the illustrated embodiment) to indicate to the system provider device the relative important of the attributes of the locations with regard to the identified or confirmed routine. The user may then select the save routine details button 1020 to save the details provided in the routine details provision section 1018. In an embodiment, additional user adjustable ranking tables may be provided for specific attributes. For example, a separate user adjustable ranking table could be provided for the BBQ restaurant attribute that allows the user to rank attributes associated with the BBQ restaurant purchase that is part of the identified or confirmed routine (e.g., ranking the importance to the user of types of meat served, restaurant opening time, etc.)

For example, the user may confirm that they do have a routine in which they go on a 20 mile bike ride once per week on Sundays, year round, and follow that bike ride with a purchase at a BBQ restaurant, and then may use the user adjustable ranking table in the routine details provision section 1018 to rank the attributes as follows: 1. BBQ restaurant, 2. Less than 250 feet elevation change, 3. Veloway, and 4. Public road. The user may then use an additional user adjustable ranking table to rank the attributes of the BBQ restaurant as follows: 1. Serves Brisket, 2. Open at 10:30 am, 3. Currently ranked as a top 10 BBQ restaurant in that location. Such rankings may be provided to inform the system provider device that, when away from their home location and on Sundays, routine recommendations for 20 mile bike rides should prioritize routes with less than a 250 foot elevation change and ending near a BBQ restaurant that is one of the top BBQ restaurants in the current location area, serves brisket, and is open early.

FIG. 11b illustrates an embodiment of the user device 900 with the display device 902 displaying a routine details screen 1112 in response to an identified or confirmed routine (e.g., the routine confirmed as discussed above with reference to FIG. 11a.) The routine details screen 1112 includes a description 1114 of the identified or confirmed routine (e.g., visiting a swimming area 2 times per week on Thursdays and Saturdays either between June and August, or if the temperature is above 85°), a routine details request 1116 that requests the user to provide routine details (e.g., by ranking attributes of the locations in the home location area that are associated with the identified or confirmed request), and a routine details provision section 1118. In the illustrated embodiment, the routine details provision section 1118 includes a user adjustable ranking table that includes each of the attributes associated with the locations that resulted in the identified routine and linked purchase on the routine identifier 1100 in FIG. 11a. Thus, in the illustrated embodiment, the user adjustable ranking table includes the attributes of the swimming areas included in the routine details section 1108 on the routine identifier 1100, and the user may order the attributes provided in the user adjustable ranking table (by dragging and dropping the attributes using an input device on the user device 900 as illustrated) into ranked positioned (e.g., ranked positions 1-5 provided on the user adjustable ranking table in the illustrated embodiment) to indicate to the system provider device the relative important of the attributes of the locations with regard to the identified or confirmed routine. The user may then select the save routine details button 1120 to save the details provided in the routine details provision section 1118

For example, the user may confirm that they do have a routine in which they visit a swimming area 2 times per week on Thursdays and Saturdays either between June and August, or if the temperature is above 85°, and follow that visit with a purchase at a snow cone vendor, and then may use the adjustable ranking table in the routine details provision section 1118 to rank the attributes as follows: 1. Natural spring, 2. Free-to-enter, 3. Pay-to-enter, 4. Snow Cone Vendor, and 5. Wifi. Such rankings may be provided to inform the system provider device that, when away from their home location and on Thursday or Sundays, either between June and August or when the temperature is above 85°, routine recommendations for swimming areas should prioritize swimming areas that include natural springs and that are free to enter.

In some embodiments, the user may be provided the ability to associate user-provided criteria with attributes of the activities/locations that resulted in the identified routine. For example, FIG. 11c illustrates an embodiment of the user device 900 with the display device 902 displaying a routine details screen 1124 that receives user-provided criteria for identified or confirmed routines (e.g., the routine confirmed as discussed above with reference to FIG. 11a.) The routine details screen 1124 includes the description 1114 of the identified or confirmed routine discussed above (e.g., visiting a swimming area 2 times per week on Thursdays and Saturdays either between June and August, or if the temperature is above 85°), the routine details request 1116 that requests the user to provide routine details discussed above (e.g., by ranking attributes of the locations in the home location area that are associated with the identified or confirmed request), and an attribute criteria provision section 1126. In the illustrated embodiment, the attribute criteria provision section 1126 includes text input boxes 1126a-e associated with each attribute of the identified or confirmed routine.

For example, the input box 1126a is associated with the natural spring attribute of the swimming area routine of the user, and the user has provided “at least 15 feet deep; at least ⅛ mile long” to instruct the system provider device that routine recommendations for the users swimming area routine should prioritize swimming areas that are at least 15 feet deep and at least ⅛ mile long (e.g., if different swimming area options are available.) In another example, the input box 1126b is associated with the free-to-enter attribute of the swimming area routine for the user, and the user has provided “at least until 10 am” to instruct the system provider device that routine recommendations for users swimming area routine should prioritize swimming areas that are free to enter until at least 10 am (e.g., if different swimming area options are available.) In another example, the input box 1126c is associated with the pay-to-enter attribute of the swimming area routine for the user, and the user has provided “no more than $3” to instruct the system provider device that routine recommendations for users swimming area routine should prioritize swimming areas that cost no more than $3 to enter (e.g., if no free-to-enter swimming areas are available and different pay-to-enter swimming area options are available.) In another example, the input box 1126d is associated with the snow cone vendor linked purchase associated with swimming area routine for the user, and the user has provided “no more than 1 mile from swimming area; including cherry flavor” to instruct the system provider device that routine recommendations for users swimming area routine should prioritize snow cone vendors within a mile of the swimming area that sell cherry flavored snow cones (e.g., if different snow cone vendor options are available.) In another example, the input box 1126e is associated with the WiFi attribute of the swimming area routine for the user, and the user has provided “must be free” to instruct the system provider device that routine recommendations for users swimming area routine should prioritize swimming areas that have free WiFi (e.g., if different swimming area options are available.)

Thus, systems and methods have been described that identify routines of user activities of a user, and allow the user to rank attributes of the activities or locations associated with those routines and provide other user criteria for those attributes that distinguish that users most desired attributes associated with those routine activities or locations. When the user travels to a different location area that is away from their home location area, the systems and methods discussed herein may provide locations in that different location area that allow for user activities associated with the confirmed routines so that the user may continue to perform those user activities during their usual time periods. Linked purchases that include purchases that are often made in association with user activities associated with confirmed routines may be used to retrieve the locations of merchants that provide the linked purchases in the different location area as well. Thus, a user's routine may be uninterrupted when that user is away from their home location area through the learning of those routines and the suggestions of locations in different location areas at which those routines may be conducted.

Once the user has confirmed a routine and provided routine details according to the method 700, routine suggestions for that confirmed routine may be provided to the user substantially similarly as described above according to the method 100 of FIG. 1. In an embodiment of the method 100, at block 104 the system provider device may detect that a current location area of the user is over a predetermined distance from their home location area, and at block 106 the system provider device may determine that a current time corresponds to a time period associated with a confirmed routine. At block 108, the system provider device may then retrieve one or more locations in the current location area that are associated with the activity or location type associated the confirmed routine (and in some embodiment, a linked purchase associated with the confirmed routine). Then, using the routine details (e.g., ranked attributes, user provided criteria, etc.) received from the user at block 708 of the method 700, the system provider device may prioritize the one or more locations in the current location area. At block 110, those prioritized current locations in the current location area may then be displayed on the user device.

Using the example of the confirmed routine discussed above with reference to FIGS. 9a and 9b, at block 108 of the method 100, the system provider device may retrieve one or more park locations in the current location area, and at block 110, those park locations may be displayed on the user device prioritized according to the ranked attributes and/or user criteria provided by the user such that, for example, park locations that include food vendors and wifi are prioritized over park locations that do not include those attributes. Using the example of the confirmed routine discussed above with reference to FIGS. 10a and 10b, at block 108 of the method 100, the system provider device may retrieve one or more 20 mile bike routes or biking locations that are near BBQ restaurants in the current location area, and at block 110, those bike routes/locations and BBQ restaurants may be displayed on the user device prioritized according to the ranked attributes and/or user criteria such that, for example, the bike routes/locations that have less than 250 feet of elevation changes and that end near a BBQ restaurant that serves brisket are prioritized over bike routes/locations and BBQ restaurants that do not have those attributes.

Using the example of the confirmed routine discussed above with reference to FIGS. 11a, 11b, and 11c, at block 108 of the method 100, the system provider device may retrieve one or more swimming areas and, in some examples snow cone vendors, in the current location area, and at block 110, those swimming areas may be displayed on the user device prioritized according to the ranked attributes and/or user criteria provided by the user such that the swimming areas that include natural springs and that are free to enter are prioritized over swimming areas that do not have those attributes. In addition, the system provider device may prioritize the swimming areas near snow cone vendors over those that are not, prioritize swimming areas that are not more than $3 to enter, prioritize snow cone vendors that are within a mile of the displayed swimming holes and that serve cherry flavored snow cones, and/or provide any other prioritization based on any other details provided by the user about the confirmed routine.

In some embodiments, a block may be added to the method 100 to determine a current temperature at the current location area that is away from the home location area, and that current temperature may be used in making the routine suggestions. For example a retrieved current temperature in the current location area may be compared to a temperature range associated with confirmed routine (e.g., over 85° during times outside of June to August in the confirmed routine associated with FIGS. 11a, 11b, and 11c) to determine whether the confirmed routine should be used to provide a routine suggestion to the user. Thus, in such an embodiment, the locations associated with a location type included in the confirmed routine discussed above with reference to FIGS. 11a, 11b, and 11c, may only be retrieved and provided to the user according to the method 100 if a current temperature at the current location area is determined to be above 85°.

In another specific example, a user activity data and purchase data may be collected in the users home location area by the system provider device that indicates that a user regularly purchases a particular type of coffee in the mornings (e.g., via purchase data received through a purchasing application on the users mobile phone) followed by a visit to a park that provides WiFi (e.g., via GPS coordinates provided by the users mobile phone, followed by a lookup (e.g., over the Internet) of the attributes of a park associated with those GPS coordinates.) The system provider device will identify this routine after it has been performed enough times, and then provide the user with a routine identifier that allows the user to confirm the routine and provide routine details. The user may then provide routine details that indicate that they prefer the particular type of coffee (e.g., French Roast) from a particular merchant (e.g., Starbucks®), along with parks that provide free WiFi and that allow dogs off their leashes. The user may then leave the home location area (e.g., go on vacation or travel for business), and the system provider device may conduct a search (e.g., the night before, as the user routine is typically performed in the morning) for merchant locations that serve coffee that are located within a half mile of a park in the current location area of the user. The system provider device may then filter the search results to prioritize the merchant locations based on those that are Starbucks® locations and/or serve French Roast coffee, and that are located within a half mile of parks with free WiFi and/or that allow dogs off their leashes. Those filtered and prioritized merchant locations and park locations may then be provided for display on the user device so that the user may quickly and easily select a merchant location for their morning coffee and a park which to visit following the purchase of that coffee, just as per their routine in the home location area.

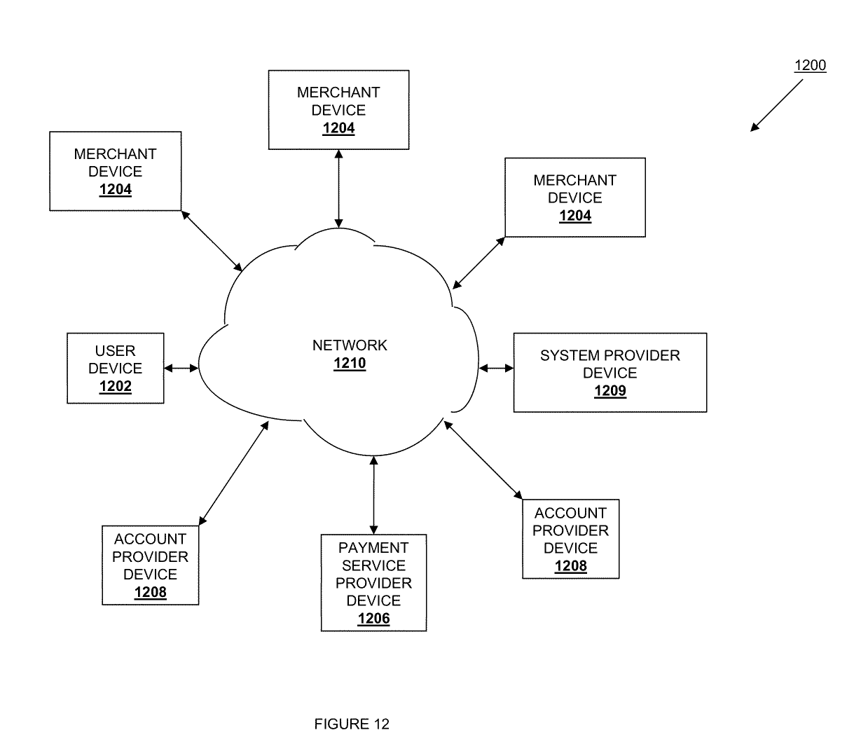

Referring now to FIG. 12, an embodiment of a network-based system 1200 for implementing one or more processes described herein is illustrated. As shown, network-based system 1200 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 12 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1200 illustrated in FIG. 12 includes a plurality of user devices 1202, a plurality of merchant devices 1204, a payment service provider device 1206, a plurality of account holder devices 1208, and/or a system provider device 1209 in communication over a network 1210. Any of the user devices 1202 may be the user device 202, 300, 802, or 900, discussed above. The merchant devices 1204 may be merchant devices operated by the merchants discussed above. The payment service provider device 1206 may be payment service provider devices operated by a payment service provider such as, for example, PayPal Inc. of San Jose, Calif. The account provider devices 1208 may be account provider devices 210 or 810 operated by the account providers discussed above such as, for example, credit card account providers, bank account providers, savings account providers, and a variety of other account providers known in the art. The system provider device 1209 may be operated by any third party system provider other than the payment service provider or account provider.

The user device 1202, merchant devices 1204, payment service provider device 1206, account provider devices 1208, and/or system provider device 1209 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1200, and/or accessible over the network 1210.

The network 1210 may be implemented as a single network or a combination of multiple networks. For example, in various embodiments, the network 1210 may include the Internet and/or one or more intranets, landline networks, wireless networks, and/or other appropriate types of networks.

The user device 1202 may be implemented using any appropriate combination of hardware and/or software configured for wired and/or wireless communication over network 1210. For example, in one embodiment, the user device 1202 may be implemented as a personal computer of a user in communication with the Internet. In other embodiments, the user device 1202 may be a smart phone, personal digital assistant (PDA), laptop computer, and/or other types of computing devices.

The user device 1202 may include one or more browser applications which may be used, for example, to provide a convenient interface to permit the user to browse information available over the network 1210. For example, in one embodiment, the browser application may be implemented as a web browser configured to view information available over the Internet.

The user device 1202 may also include one or more toolbar applications which may be used, for example, to provide user-side processing for performing desired tasks in response to operations selected by the user. In one embodiment, the toolbar application may display a user interface in connection with the browser application.

The user device 1202 may further include other applications as may be desired in particular embodiments to provide desired features to the user device 1202. In particular, the other applications may include a payment application for payments assisted by a payment service provider through the payment service provider device 1206. The other applications may also include security applications for implementing user-side security features, programmatic user applications for interfacing with appropriate application programming interfaces (APIs) over the network 1210, or other types of applications. Email and/or text applications may also be included, which allow the user to send and receive emails and/or text messages through the network 1210. The user device 1202 includes one or more user and/or device identifiers which may be implemented, for example, as operating system registry entries, cookies associated with the browser application, identifiers associated with hardware of the user device 1202, or other appropriate identifiers, such as a phone number. In one embodiment, the user identifier may be used by the payment service provider device 1206 and/or account provider device 1208 and/or system provider device 1209 to associate the user with a particular account or database entries as further described herein.

The merchant device 1204 may be maintained, for example, by a conventional or on-line merchant, conventional or digital goods seller, individual seller, and/or application developer offering various products and/or services in exchange for payment to be received conventionally or over the network 1210. In this regard, the merchant device 1204 may include a database identifying available products and/or services (e.g., collectively referred to as items) which may be made available for viewing and purchase by the user.

The merchant device 1204 also includes a checkout application which may be configured to facilitate the purchase by the payer of items. The checkout application may be configured to accept payment information from the user through the user device 1202, the account provider through the account provider device 1208, from the payment service provider through the payment service provider device 706, and/or the system provider through the system provider device 1209 over the network 1210.

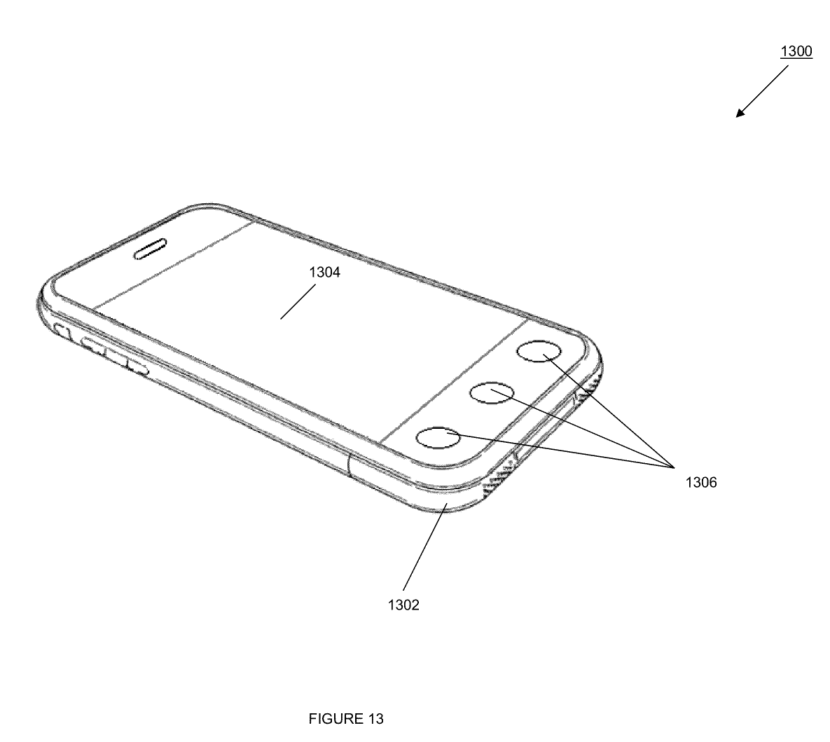

Referring now to FIG. 13, an embodiment of a user device 1300 is illustrated. The user device 1300 may be the user devices 202, 300, 802, 900, and/or 1202, discussed above. The user device 1300 includes a chassis 1302 having a display 1304 and an input device including the display 1304 and a plurality of input buttons 1306. One of skill in the art will recognize that the user device 1300 is a portable or mobile phone including a touch screen input device and a plurality of input buttons that allow the functionality discussed above with reference to the methods 100 or 700. However, a variety of other portable/mobile user devices and/or desktop user devices may be used in the methods 100 or 700 without departing from the scope of the present disclosure.

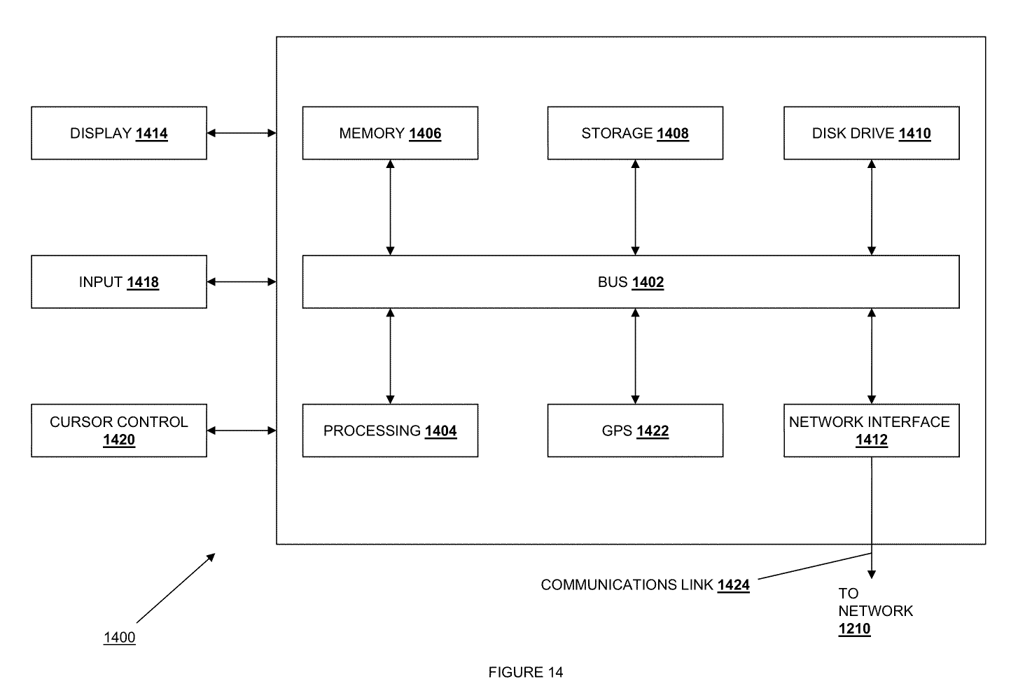

Referring now to FIG. 14, an embodiment of a computer system 1400 suitable for implementing, for example, the user device 202, the user device 300, the user device 802, the user device 900, the user device 1202, the user device 1300, the merchant devices 1204, the payment service provider device 1206, the account provider device 210, 810, or 1208, and/or the system provider device 206, 806, or 1209, is illustrated. It should be appreciated that other devices utilized by user, merchants, payment service providers, account providers, and/or system provider devices in the payment system discussed above may be implemented as the computer system 1400 in a manner as follows.

In accordance with various embodiments of the present disclosure, computer system 1400, such as a personal computer and/or a network server, includes a bus 1402 or other communication mechanism for communicating information, which interconnects subsystems and components, such as a processing component 1404 (e.g., processor, micro-controller, digital signal processor (DSP), etc.), a system memory component 1406 (e.g., RAM), a static storage component 1408 (e.g., ROM), a disk drive component 1410 (e.g., magnetic or optical), a network interface component 1412 (e.g., modem or Ethernet card), a display component 914 (e.g., CRT or LCD), an input component 1418 (e.g., keyboard, keypad, or virtual keyboard), a cursor control component 1420 (e.g., mouse, pointer, or trackball), and/or a location determination component 1422 (e.g., a Global Positioning System (GPS) device as illustrated, a cell tower triangulation device, and/or a variety of other location determination devices known in the art.) In one implementation, the disk drive component 1410 may comprise a database having one or more disk drive components.

In accordance with embodiments of the present disclosure, the computer system 1400 performs specific operations by the processor 1404 executing one or more sequences of instructions contained in the memory component 1406, such as described herein with respect to the user devices 202, 300, 802, 900, 1202, and 1300, the merchant devices 1204, the payment service provider device 1206, the account provider device(s) 210, 810, and 1208, and/or the system provider device 210, 810, or 709. Such instructions may be read into the system memory component 1406 from another computer readable medium, such as the static storage component 1408 or the disk drive component 1410. In other embodiments, hard-wired circuitry may be used in place of or in combination with software instructions to implement the present disclosure.

Logic may be encoded in a computer readable medium, which may refer to any medium that participates in providing instructions to the processor 1404 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1410, volatile media includes dynamic memory, such as the system memory component 1406, and transmission media includes coaxial cables, copper wire, and fiber optics, including wires that comprise the bus 1402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1400. In various other embodiments of the present disclosure, a plurality of the computer systems 1400 coupled by a communication link 1424 to the network 1210 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1400 may transmit and receive messages, data, information and instructions, including one or more programs (i.e., application code) through the communication link 1424 and the network interface component 1412. The network interface component 1412 may include an antenna, either separate or integrated, to enable transmission and reception via the communication link 1424. Received program code may be executed by processor 1404 as received and/or stored in disk drive component 1410 or some other non-volatile storage component for execution.

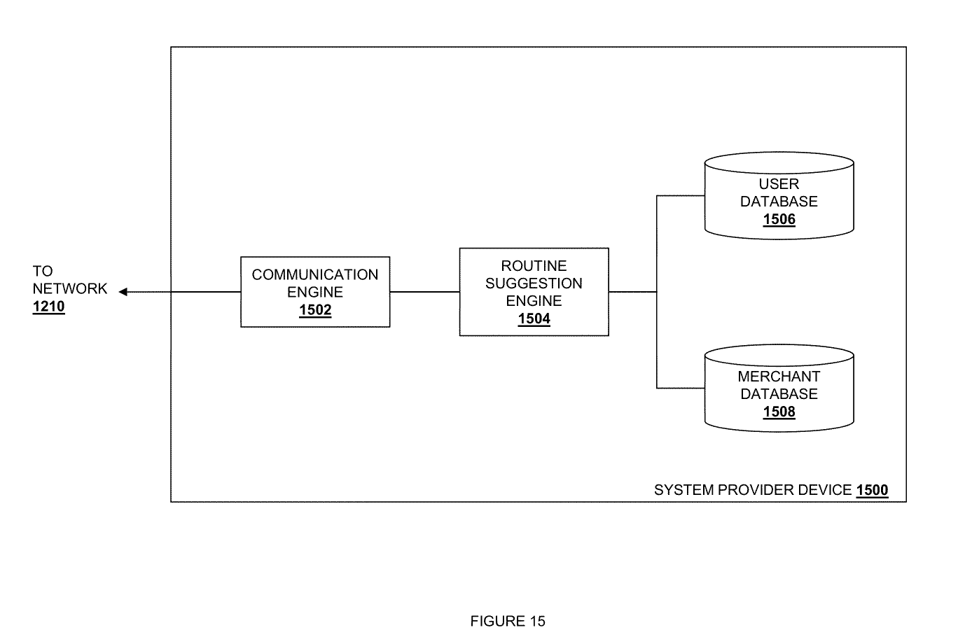

Referring now to FIG. 15, an embodiment of a user device/payment service provider device/account provider device/system provider device 1500 is illustrated. In an embodiment, the device 1500 may be the user devices 202, 300, 802, 900, 1202, and 1300, the payment service provider device 1206, the account holder device 210, 810, and 1208, and/or the system provider device 206, 806, and 1209. The device 1500 includes a communication engine 1502 that is coupled to the network 1210 and to a routine suggestion engine 1504 that is coupled to a user database 1506 and a merchant database 1508. The communication engine 1502 may be software or instructions stored on a computer-readable medium that allows the device 1500 to send and receive information over the network 1210. The routine suggestion engine 1504 may be software or instructions stored on a computer-readable medium that allows the device 1500 to receive purchase data, determine routine data and store it in the user database 1506, detect a current location, determine that the current location is over a predetermined distance from a home location stored in the user database 1506, determine a current time, determine that a current time corresponds to a time period associated with a routine purchase type in the user database 1506, retrieve merchants associated with a current location that provide a routine purchase type from the merchant database 1508, display merchants, determine that a routine purchase type has been made that is associated with a linked purchase type in the user database 1506, retrieve linked merchants that are associated with the current location and that provide the linked purchase type from the merchant database 1508, display linked merchants, receive user activity data, associate user activity data with user accounts in the user database 1506, determine subsets of the user activity data that include a common location type and a reoccurring time period, provide a routine identifier to a user device, receive route details from a user device, associate a routine suggestion with the user, determine a current temperature in a current location area, and provide any of the other functionality that is discussed herein. While the databases 1006 and 1008 have been illustrated as located in the device 1500, one of skill in the art will recognize that they may be connected to the routine suggestion engine 1504 through the network 1210 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing a user account associated with a user, wherein the user account includes a home location area;
one or more hardware processors coupled to the memory and operable to read instructions from the memory to perform the steps of:
receiving a plurality of user activity data associated with locations that are within the home location area at a plurality of different times, and
associating the plurality of user activity data with the user account in the non-transitory memory;
determining that a subset of the plurality of user activity data associated with the user account in the non-transitory memory includes a location type and a reoccurring time period;
providing a routine identifier on a user device that includes the location type and a plurality of attributes associated with the location type;
receiving, from the user device, routine details that rank the plurality of attributes associated with the location type; and
associating a confirmed routine with the user account in the non-transitory memory, wherein the confirmed routine includes the location type, the reoccurring time period, and the ranked plurality of attributes.

2. The system of claim 1, wherein the plurality of user activity data associated with locations within the home location area at the plurality of different times includes temperature data, and wherein the one or more hardware processors are operable to read instructions from the memory to perform the steps of:
determining that the subset of the plurality of user activity data associated with the user account in the non-transitory memory includes a location type, a reoccurring time period, and a temperature range, wherein the confirmed routine includes the location type, the ranked plurality of attributes, the reoccurring time period, and the temperature range.

3. The system of claim 1, wherein the routine details include user-provided criteria about at least one of the plurality of attributes, and wherein the confirmed routine includes the location type, the reoccurring time period, the ranked plurality of attributes, and the user-provided criteria about the at least one of the plurality of attributes.

4. The system of claim 1, wherein the one or more hardware processors are operable to read instructions from the memory to perform the steps of:
determining that the user device is in a current location area that is over a predetermined distance from the home location area associated with the user account in the non-transitory memory;
determining that a current time corresponds to the reoccurring time period included in the confirmed routine that is associated with the user account in the non-transitory memory;
retrieving a first location over a network that is within the current location area, is associated with the location type included in the confirmed routine, and includes at least some of the plurality of attributes associated with the location type; and
providing the first location for display on the user device.

5. The system of claim 4, wherein the one or more hardware processors are operable to read instructions from the memory to perform the steps of:
retrieving a plurality of first locations over the network that are each within the current location area, are each associated with the location type included in the confirmed routine, and each includes at least some of the plurality of attributes associated with the location type;
prioritizing the plurality of first locations based on the ranked plurality of attributes associated with the confirmed routine and the at least some of the plurality of attributes associated with the location type and included in those plurality of first locations; and
providing the plurality of first locations for display according to their ranking on the user device.

6. The system of claim 4, wherein the one or more hardware processors are operable to read instructions from the memory to perform the steps of:
determining that a current temperature corresponds to a temperature range included in the CONFIRMED ROUTINE that is associated with the user account in the non-transitory memory and, in response, retrieving the first location over the network that is within the current location area.

7. A method for providing routine suggestions, comprising:
receiving, from a user device associated with a home location area, a plurality of user activity data associated with locations that are within the home location area at a plurality of different times, and associating the plurality of user activity data with a user account in a database;
determining that a subset of the plurality of user activity data associated with the user account in the database includes a location type and a reoccurring time period;
providing a routine identifier on the user device that includes the location type and a plurality of attributes associated with the location type;
receiving, from the user device, routine details that rank the plurality of attributes associated with the location type; and
associating a confirmed routine with the user account in the database, wherein the confirmed routine includes the location type, the reoccurring time period, and the ranked plurality of attributes.

8. The method of claim 7, wherein the plurality of user activity data associated with locations within the home location area at the plurality of different times includes temperature data, and wherein the method further comprises:
determining that the subset of the plurality of user activity data associated with the user account in the database includes a location type, a reoccurring time period, and a temperature range, wherein the confirmed routine includes the location type, the ranked plurality of attributes, the reoccurring time period, and the temperature range.

9. The method of claim 8, wherein the routine details include user-provided criteria about at least one of the plurality of attributes, and wherein the confirmed routine includes the location type, the reoccurring time period, the ranked plurality of attributes, and the user-provided criteria about the at least one of the plurality of attributes.

10. The method of claim 7, further comprising:
determining that the user device is in a current location area that is over a predetermined distance from the home location area associated with the user account in the database;
determining that a current time corresponds to the reoccurring time period included in the confirmed routine that is associated with the user account in the database;
retrieving a first location over a network that is within the current location area, is associated with the location type included in the confirmed routine, and includes at least some of the plurality of attributes associated with the location type; and
providing the first location for display on the user device.

11. The method of claim 10, further comprising:
retrieving a plurality of first locations over the network that are each within the current location area, are each associated with the location type included in the confirmed routine, and each includes at least some of the plurality of attributes associated with the location type;
prioritizing the plurality of first locations based on the ranked plurality of attributes associated with the confirmed routine and the at least some of the plurality of attributes associated with the location type and included in those plurality of first locations; and
providing the plurality of first locations for display according to their ranking on the user device.

12. The method of claim 10, further comprising:
determining that a current temperature corresponds to a temperature range included in the confirmed routine that is associated with the user account in the non-transitory memory and, in response, retrieving the first location over the network that is within the current location area.

13. The method of claim 7, further comprising:
determining that the subset of the plurality of user activity data associated with the user account in the database includes the location type, the reoccurring time period, and a linked purchase;
providing the routine identifier on the user device that includes the location type, the linked purchase, and a plurality of attributes associated with the location type and the linked purchase;
receiving, from the user device, routine details that rank the plurality of attributes associated with the location type and the linked purchase; and
associating a confirmed routine with the user account in the database, wherein the confirmed routine includes the location type, the linked purchase, the reoccurring time period, and the ranked plurality of attributes.

14. A non-transitory machine-readable medium comprising a plurality of machine-readable instructions which, when executed by one or more processors, are adapted to cause the one or more processors to perform a method comprising:
receiving, from a user device associated with a home location area, a plurality of user activity data associated with locations that are within the home location area at a plurality of different times, and associating the plurality of user activity data with a user account in a database;
determining that a subset of the plurality of user activity data associated with the user account in the database includes a location type and a reoccurring time period;
providing a routine identifier on the user device that includes the location type and a plurality of attributes associated with the location type;
receiving, from the user device, routine details that rank the plurality of attributes associated with the location type; and
associating a confirmed routine with the user account in the database, wherein the confirmed routine includes the location type, the reoccurring time period, and the ranked plurality of attributes.

15. The non-transitory machine-readable medium of claim 14, wherein the plurality of user activity data associated with locations within the home location are at the plurality of different times includes temperature data, and wherein the method further comprises:
determining that the subset of the plurality of user activity data associated with the user account in the database includes a location type, a reoccurring time period, and a temperature range, wherein the confirmed routine includes the location type, the ranked plurality of attributes, the reoccurring time period, and the temperature range.

16. The non-transitory machine-readable medium of claim 15, wherein the routine details include user-provided criteria about at least one of the plurality of attributes, and wherein the confirmed routine includes the location type, the reoccurring time period, the ranked plurality of attributes, and the user-provided criteria about the at least one of the plurality of attributes.

17. The non-transitory machine-readable medium of claim 14, wherein the method further comprises:
determining that the user device is in a current location area that is over a predetermined distance from the home location area associated with the user account in the database;
determining that a current time corresponds to the reoccurring time period included in the confirmed routine that is associated with the user account in the database;
retrieving a first location over a network that is within the current location area, is associated with the location type included in the confirmed routine, and includes at least some of the plurality of attributes associated with the location type; and
providing the first location for display on the user device.

18. The non-transitory machine-readable medium of claim 14, wherein the method further comprises:
retrieving a plurality of first locations over the network that are each within the current location area, are each associated with the location type included in the confirmed routine, and each includes at least some of the plurality of attributes associated with the location type;
prioritizing the plurality of first locations based on the ranked plurality of attributes associated with the confirmed routine and the at least some of the plurality of attributes associated with the location type and included in those plurality of first locations; and
providing the plurality of first locations for display according to their ranking on the user device.

19. The non-transitory machine-readable medium of claim 14, wherein the method further comprises:
determining that a current temperature corresponds to a temperature range included in the confirmed routine that is associated with the user account in the non-transitory memory and, in response, retrieving the first location over the network that is within the current location area.

20. The non-transitory machine-readable medium of claim 14, wherein the method further comprises:
determining that the subset of the plurality of user activity data associated with the user account in the database includes the location type, the reoccurring time period, and a linked purchase;
providing the routine identifier on the user device that includes the location type, the linked purchase, and a plurality of attributes associated with the location type and the linked purchase;
receiving, from the user device, routine details that rank the plurality of attributes associated with the location type and the linked purchase; and
associating a confirmed routine with the user account in the database, wherein the confirmed routine includes the location type, the linked purchase, the reoccurring time period, and the ranked plurality of attributes.
